(19) United States
(12) Patent Application Publication
(10) Pub. No.: US 2014/0155265 A1
(43) Pub. Date: Jun. 5, 2014

(54) HERBICIDAL COMPOSITIN COMPRISING PINOXADEN AND FLUROXYPYR AND METHODS OF USE THEREOF

(71) Applicants: Donald John Porter, Greensboro, NC (US); Shawn Chignell Potter, Greensboro, NC (US); Xinyun Wen, Greensboro, NC (US); Colin Douglas Miln, Greensboro, NC (US)

(72) Inventors: Donald John Porter, Greensboro, NC (US); Shawn Chignell Potter, Greensboro, NC (US); Xinyun Wen, Greensboro, NC (US); Colin Douglas Miln, Greensboro, NC (US)

(73) Assignee: SYNGENTA PARTICIPATIONS AG, Basel (CH)

(21) Appl. No.: 14/115,879

(22) PCT Filed: Apr. 13, 2012
(86) PCT No.: PCT/EP2012/056766

§ 371 Date: Dec. 9, 2013

Related U.S. Application Data
(60) Provisional application No. 61/483,269, filed on May 6, 2011.

(51) Int. Cl. A01N 25/04; A01N 37/34; A01N 43/56; A01N 43/40; A01N 43/90

(52) U.S. Cl. CPC A01N 25/04; A01N 43/40; A01N 43/90; A01N 43/56; A01N 37/34
USPC 504/134; 504/130; 504/136

(57) ABSTRACT

The invention provides a liquid herbicidal composition in the form of an emulsifiable concentrate, comprising a mixture of: (i) pinoxaden; (ii) a C₁-C₁₂alkyl ester or a 2-(C₁-C₆alkoxy)C₂-C₄alkyl-ester of fluoroxypyr; and (iii) a built-in phosphate and/or phosphonate adjuvant as defined herein; preferably tris-(2-ethylhexyl) phosphate. The invention also provides a method for controlling and/or inhibiting the growth of weeds from the genus Kochia, comprising applying a liquid herbicidal composition to these weeds or to their locus, at a time after emergence of the weeds, wherein the liquid herbicidal composition comprises a mixture of: (i) pinoxaden; (ii) a ester of fluoroxypyr; and (iii) a built-in phosphate and/or phosphonate adjuvant as defined herein. The invention also provides methods for controlling and/or inhibiting dicotyledonous and/or broadleaf weeds, preferably weeds from the genus Kochia, Polygonum, Fallopia, Salsola, Descurainia, Helianthus, Lactuca, Solanum, Sinapsis, Amaranthus, Brassica, Chenopodium and/or Fagopyrum. The invention also provides a liquid herbicidal composition, which has herbicidal activity against a broad spectrum of broadleaf weeds, comprising a mixture of: (i) pinoxaden; (ii) an ester of fluoroxypyr; and either (a) pyrasulfotole, and bromoxynil or an ester thereof; or (b) MCPA or an ester thereof, and a fourth herbicide which is florasulam, prosulfuron or triasulfuron.

The present invention relates to a liquid herbicidal composition, in particular in the form of an emulsifiable concentrate (EC), comprising inter alia pinoxaden and an ester of fluoroxypyr. The present invention also relates to methods for controlling and/or inhibiting the growth of dicotyledonous and/or broadleaf weeds, in particular weeds from the genus Kochia, Polygonum, Fallopia, Salsola, Descurainia, Helianthus, Lactuca, Solanum, Sinapsis, Amaranthus, Brassica, Chenopodium and/or Fagopyrum, comprising applying to the weeds or to their locus a liquid herbicidal composition comprising inter alia pinoxaden and an ester of fluoroxypyr. The present invention also relates to liquid herbicidal compositions comprising four active herbicidal substances, namely: (i) pinoxaden, (ii) an ester of fluoroxypyr, (iii) a third selected broadleaf weed herbicide, and (iv) a fourth selected broadleaf weed herbicide.

Pinoxaden is a herbicide suitable for use on non-oat cereals such as wheat, barley, rye and/or triticale, especially wheat and/or barley, and is typically applied post-emergence for control of grassy weeds such as those from the genus Alopecurus, Apera, Avena, Lolium, Phalaris or Setaria, e.g. at application rates of from 30 to 60 g of pinoxaden/ha (ha=hectare); pinoxaden is typically and preferably used in admixture with cloquintocet-mexyl as a safener (these features, e.g. uses and/or application rates and/or safener can be used in the present invention). Emulsifiable concentrate (EC) formulations of pinoxaden are available from Syngenta in many countries, typically under the trade mark Axial™; e.g. in the USA it is available under the trade mark Axial™ and Axial XL™. Pinoxaden is disclosed as Example H9 and as Compound no. 1.008 in WO 99/47525 A1 (Novartis AG). Pinoxaden and its herbicidal uses are disclosed in: M. Muehlebach et al., Bioorganic & Medicinal Chemistry, 2009, vol. 17, pp. 4241-4256; M. Muehlebach et al., in “Pesticide Chemistry. Crop Protection, Public Health, Environmental Safety”, ed. H. Ohkawa et al., 2007, Wiley, Weinheim, pp. 101-110; U. Hofer et al. Journal of Plant Diseases and Protection, 2006, Special Issue XX, pp. 989-995; and “The Pesticide Manual”, ed. C. D. S. Tomlin, 15th edition, 2009, British Crop Production Council, UK, see entry 687 “pinoxaden” on pp. 911-912. Pinoxaden is 8-(2,6-diethyl-4-methylphenyl)-1,2,4,5-tetrahydro-7-oxo-7H-pyrazolo[1,2-d][1,4,5]oxadiazepin-9-yl 2,2-dimethylpropionate and has the following structure:

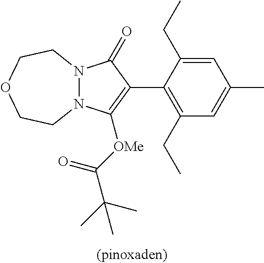

WO 01/17351 A1 (Syngenta Participations AG) discloses herbicidal compositions comprising (a) a genus of herbicidal fused 3-hydroxy-4-(4-methylphenyl)-5-oxo-pyrazoline derivatives encompassing, and exemplifying, pinoxaden; and (b) a co-herbicide selected the classes of phenoxy-phenoxypropionic acids (e.g. clodinafop-propargyl, diclofop-methyl, fluazifop-P-butyl, et al.), hydroxylamines (e.g. tralkoxydim, et al.), sulfonylureas (e.g. triasulfuron, et al.), imidazolinones, pyrimidines, triazines, ureas, PPO, chloroacetanilides, phenoxyacetic acids, triazinones, dinitroanilines, azinones, carbamates, oxyacetamides, thiolcarbamates, azoleureas, benzoic acids, anilides, nitriles, triones and sulfonamides (e.g. chlorasulam, diclsulam, florasulam, et al.), as well as from the herbicides amitrol, benfuresate, bentazone, cinmethylin, clomazone, chlopyralid, difenzoquat, dithiopyr, ethofumesate, fluorochloridone, indanofane, isoxaben, oxaziclomefone, pyridate, pyridafol, quinchlorac, quinmerac, tridiphane and flamprop. Pages 10-11 of WO 01/17351 A1 disclose a long list of possible co-herbicides which can be used, including fluoroxypyr.

WO 2007/073933 A2 (Syngenta Participations AG) discloses emulsifiable concentrates containing, in addition to emulsifiers and water-insoluble solvents, a) pinoxaden and b) an alcohol, preferably benzyl alcohol, tetrahydrofurfuryl alcohol or 2-methyl-2,4-pentanediol.

WO 2008/049618 A2 (Syngenta Participations AG) discloses a liquid herbicidal composition containing pinoxaden and an adjuvant, where the adjuvant is a built-in adjuvant consisting of a tris-ester of phosphoric acid with aliphatic or aromatic alcohols and/or a bis-ester of alkyl phosphonic acids with aliphatic or aromatic alcohols. WO 2008/049618 discloses the following preferred built-in adjuvants: the tris-ester of phosphoric acid is preferably tris-(2-ethylhexyl) phosphate, tris-n-octyl phosphate or tris-butoxyethyl phosphate; and the bis-ester of alkyl phosphonic acids is preferably bis-(2-ethylhexyl)-(2-ethylhexyl)-phosphonate, bis-(2-ethylhexyl)-(n-octyl)-phosphonate, dibutyl-butyl phosphonate or bis(2-ethylhexyl)-tripropylene-phosphonate. WO 2008/049618 (e.g. pages 7-9 thereof) discloses that Example 1 compositions A and B therein, which are emulsifiable concentrates (EC's) containing inter alia pinoxaden (as the sole herbicide), tetrahydrofurfuryl alcohol (as one of the solvents), and tris-(2-ethylhexyl) phosphate (as the built-in adjuvant), showed an enhanced chemical stability of pinoxaden, in comparison to other pinoxaden EC formulations containing different built-in adjuvants. The good herbicidal efficacy of the pinoxaden on the grassy weeds from the genera Alopecurus, Apera, Avena, Lolium, and Phalaris was also maintained (see WO 2008/049618, Example 3, pages 10-11). WO 2008/049618 discloses on page 6 that the weeds to be controlled may be both monocotyledonous and dicotyledonous weeds, such as, for example, Stellaria, Apera, Avena, Setaria, Sinapis, Lolium, Echinochloa, Bromus, Alopecurus, Phalaris, Amaranthus, Chenopodium, Convolvulus, Chrysanthemum, Papaver, Cirsium, Polygonum, Matricaria, Galium, Viola and Veronica. WO 2008/049618 discloses on page 5 that a further co-herbicide in addition to pinoxaden can optionally be incorporated into the composition.

Fluoroxypyr is a herbicide typically used by post-emergence foliar application to control broadleaf weeds; see “The Pesticide Manual”, ed. C. D. S. Tomlin, 15th edition, 2009, British Crop Production Council, UK, see entry 414 “fluoroxypyr” on pp. 549-551. Fluoroxypyr, as a herbicide, is typically available as i) the free carboxylic acid, or more usually as: ii) the 1-methylheptyl (“meptyl”) ester of fluoroxypyr, typically named fluoroxypyr-meptyl; or iii) the 2-butoxy-1-methylethyl ester of fluoroxypyr, typically named fluoroxypyr-2-butoxy-1-methylethyl. The structures of these three are as follows:

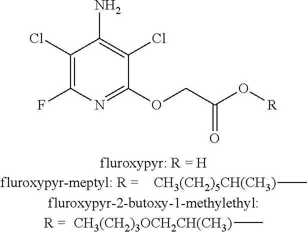

An emulsifiable concentrate (EC) formulation of fluoroxypyr-meptyl is available from Dow AgroSciences, and in the USA and Australia this is available under the trade mark Starane™.

It has now been found that a “premixed” liquid herbicidal composition, more specifically in the form of an emulsifiable concentrate (EC), which comprises pinoxaden, fluoroxypyr-meptyl, and tris-(2-ethylhexyl) phosphate (TEHP) as a built-in adjuvant (specifically, with the formulation shown in Formulation Example 1 herein), appears to show herbicidal efficacy, which is good and/or acceptable and/or somewhat improved, in controlling a number of dicotyledonous and/or broadleaf weeds, in particular weeds from the genus Kochia, Polygonum, Fallopia, Salsola, Descurainia, Helianthus, Lactuca, Sinapsis and/or Amaranthus, when applied to the weeds post-emergence, and e.g. after having been diluted with an aqueous solvent to create an aqueous composition. Efficacy is particularly good on weeds from the genus Kochia and/or Polygonum/Fallopia, which are common US and Canadian weeds.

In certain circumstances, this “premixed” EC formulation comprising pinoxaden, fluoroxypyr-meptyl and TEHP (specifically, Formulation Example 1 herein) appears to show somewhat of an improvement in the control of certain dicotyledonous and/or broadleaf weeds, in particular weeds from the genus Kochia, Salsola, Descurainia, Helianthus, Sinapsis and/or Brassica (and sometimes Amaranthus and/or Chenopodium genus weeds), either when compared to an EC containing pinoxaden and TEHP tank-mixed with an EC containing fluoroxypyr (Starane™) (see Biological Examples 1 and 2 herein), or when compared to an EC containing fluoroxypyr (Starane™) alone (see Biological Examples 1 and 3 herein).

Also, the EC composition comprising pinoxaden, fluoroxypyr-meptyl, and tris-(2-ethylhexyl) phosphate, when using the formulation shown in Formulation Example 1 herein, also appears to be stable with respect to pinoxaden chemical stability, with a low amount of pinoxaden breakdown. In contrast, EC compositions comprising pinoxaden and fluoroxypyr free carboxylic acid were generally found to be less chemically stable.

A first aspect of the invention provides a liquid herbicidal composition in the form of an emulsifiable concentrate (EC), comprising a mixture of:

(i) pinoxaden;
(ii) a C₁-C₁₂alkyl ester or a 2-(C₁-C₆alkoxy)C₂-C₄alkyl-ester of fluoroxypyr; and
(iii) a built-in phosphate and/or phosphonate adjuvant;
wherein the built-in phosphate and/or phosphonate adjuvant comprises a tris-[C₄-C₁₂alkyl or 2-(C₂-C₆alkoxy)C₂-C₄alkyl-]ester of phosphoric acid and/or a bis-(C₃-C₁₂alkyl) ester of a C₃-C₁₂alkyl-phosphonic acid.

Preferably, the liquid herbicidal composition in the form of an emulsifiable concentrate (EC) contains substantially no water (in particular less than 1% w/w of water, more particularly less than 0.5% w/w, e.g. equal to or less than 0.2% w/w, e.g. less than 0.1% w/w, by weight of the liquid herbicidal composition).

A second aspect of the present invention provides a method for controlling and/or inhibiting the growth of weeds from the genus Kochia, comprising applying a liquid herbicidal composition (preferably an aqueous liquid herbicidal composition) to the weeds from the genus Kochia or to the locus thereof, at a time after emergence of the weeds, wherein the liquid herbicidal composition comprises a mixture of:

(i) pinoxaden;
(ii) a C₁-C₁₂alkyl ester or a 2-(C₁-C₆alkoxy)C₂-C₄alkyl-ester of fluoroxypyr; and
(iii) a built-in phosphate and/or phosphonate adjuvant;
wherein the built-in phosphate and/or phosphonate adjuvant comprises a tris-[C₄-C₁₂alkyl or 2-(C₂-C₆alkoxy)C₂-C₄alkyl-]ester of phosphoric acid and/or a bis-(C₃-C₁₂alkyl) ester of a C₃-C₁₂alkyl-phosphonic acid.

Preferably, in the second aspect, a first liquid herbicidal composition (more preferably in the form of an emulsifiable concentrate (EC), still more preferably a liquid herbicidal composition as defined in the first aspect of the invention) is mixed, in a container (e.g. in a tank such as a spray tank),

with an agriculturally-acceptable aqueous solvent which is a carrier suitable for spraying the liquid herbicidal composition onto a field (e.g. water), and
optionally with one, two or more further herbicidal compositions which each independently comprise(s) one or more further herbicides;
to form a diluted aqueous liquid herbicidal composition; and
the diluted aqueous liquid herbicidal composition is applied (preferably by spraying) to the weeds from the genus Kochia, or to the locus thereof, at a time after emergence of the weeds.

In this embodiment, more preferably, the first liquid herbicidal composition, e.g. in the form of an emulsifiable concentrate (EC), contains substantially no water (in particular less than 1% w/w of water, more particularly less than 0.5% w/w, e.g. equal to or less than 0.2% w/w, e.g. less than 0.1% w/w, by weight of the liquid herbicidal composition).

A third aspect of the present invention provides a method for controlling and/or inhibiting the growth of dicotyledonous and/or broadleaf weeds (preferably weeds from the genus Kochia, Polygonum, Fallopia, Salsola, Descurainia, Helianthus, Lactuca, Solanum, Sinapsis, Amaranthus, Brassica, Chenopodium and/or Fagopyrum), the method comprising the following steps (a) and (b):

(a) mixing, in a container (e.g. in a tank such as a spray tank):
(i) a first herbicidal composition,
(ii) an agriculturally-acceptable aqueous solvent which is a carrier suitable for spraying the first herbicidal composition onto a field, and
(iii) optionally, one, two or more further herbicidal compositions,
to form a diluted aqueous liquid herbicidal composition; and
(b) applying (preferably spraying) the diluted aqueous liquid herbicidal composition to the dicotyledonous and/or broadleaf weeds (preferably weeds from the genus Kochia, Polygonum, Fallopia, Salsola, Descurainia, Helianthus, Lactuca, Solanum, Sinapsis, Amaranthus, Brassica, Chenopodium and/or Fagopyrum), or to the locus thereof, at a time after emergence of the weeds;
and wherein the first herbicidal composition is liquid and comprises a mixture of:
(ia) pinoxaden;
(ib) a C₁-C₁₂alkyl ester or a 2-(C₁-C₆alkoxy)C₂-C₄alkyl-ester of fluoroxypyr; and
(ic) a built-in phosphate and/or phosphonate adjuvant; wherein the built-in phosphate and/or phosphonate adjuvant comprises a tris-[C₄-C₁₂alkyl or 2-(C₂-C₆alkoxy)C₂-C₄alkyl-]ester of phosphoric acid and/or a bis-(C₃-C₁₂alkyl) ester of a C₃-C₁₂alkyl-phosphonic acid;
and wherein the optional one, two or more further herbicidal compositions each independently comprise(s) one or more further herbicides.

In the third aspect of the invention, the first, liquid, herbicidal composition is preferably in the form of an emulsifiable concentrate (EC).

In the third aspect of the invention, preferably, the first, liquid, herbicidal composition, e.g. in the form of an emulsifiable concentrate (EC), contains substantially no water (in particular less than 1% w/w of water, more particularly less than 0.5% w/w, e.g. equal to or less than 0.2% w/w, e.g. less than 0.1% w/w, by weight of the first, liquid, herbicidal composition).

In one particular embodiment of the second and/or third aspects of the invention, in the method, the optional one, two or more further herbicidal compositions, which each independently comprise(s) one or more further herbicides, are present (i.e. are mixed in the container).

In the second and/or third aspects of the invention, preferably, the optional one or more further herbicides, if present (i.e. if mixed in the container), are suitable for controlling and/or inhibiting the growth of dicotyledonous and/or broadleaf weeds.

In one preferable embodiment of the second and/or third aspects of the invention, the one, two or more further herbicidal compositions, which each independently comprise(s) one or more further herbicides, are present (i.e. are mixed in the container) and comprise (e.g. either together in one further herbicidal composition or separately in two or more further herbicidal compositions):

(iiia) pyrasulfotole or an agriculturally-acceptable salt thereof; and
(iiib) bromoxynil, or one or more C₄-C₁₂alkanoate esters thereof, or the butyrate ester thereof, or an agriculturally-acceptable base-addition salt thereof.
(See preferred features of the fourth aspect of the invention hereinafter for preferred features of this pyrasulfotole-containing embodiment).

In an alternative preferable embodiment of the second and/or third aspects of the invention, the one, two or more further herbicidal compositions, which each independently comprise(s) one or more further herbicides, are present (i.e. are mixed in the container) and comprise (e.g. either together in one further herbicidal composition or separately in two or more further herbicidal compositions):

(iiic) MCPA, or a C₁-C₁₂alkyl ester or a 2-(C₁-C₆alkoxy)C₂-C₄alkyl-ester thereof, or an agriculturally-acceptable base-addition salt thereof; and
(iiid) a fourth herbicide which is: florasulam, prosulfuron, triasulfuron, or an agriculturally-acceptable base-addition salt of any of these.
(See preferred features of the fifth aspect of the invention hereinafter for preferred features of this MCPA-containing embodiment).

In all aspects of the invention, in particular in the third aspect of the invention, preferably, the dicotyledonous and/or broadleaf weeds, e.g. to be controlled and/or growth-inhibited (e.g. by the fluoroxypyr ester), comprise (e.g. are) weeds from the genus Kochia, Polygonum, Fallopia, Salsola, Descurainia, Helianthus, Lactuca, Solanum, Sinapsis, Amaranthus, Brassica, Chenopodium and/or Fagopyrum. More preferably, the dicotyledonous and/or broadleaf weeds, e.g. to be controlled and/or growth-inhibited (e.g. by the fluoroxypyr ester), comprise (e.g. are) weeds from the genus Kochia, Polygonum, Fallopia, Salsola, Descurainia, Helianthus, Lactuca, Sinapsis and/or Amaranthus. Still more preferably, the dicotyledonous and/or broadleaf weeds, e.g. to be controlled and/or growth-inhibited (e.g. by the fluoroxypyr ester), comprise (e.g. are) weeds from the genus Kochia, Salsola, Descurainia, Helianthus, Lactuca and/or Sinapsis. Yet more preferably, dicotyledonous and/or broadleaf weeds, e.g. to be controlled and/or growth-inhibited (e.g. by the fluoroxypyr ester), comprise (e.g. are) weeds from the genus Kochia, Salsola, Descurainia and/or Helianthus.

In all aspects of the invention, in particular in the second and/or third aspects of the invention, most preferably, the dicotyledonous and/or broadleaf weeds, e.g. to be controlled and/or growth-inhibited (e.g. by the fluoroxypyr ester), comprise (e.g. are) weeds from the genus Kochia (e.g. Kochia scoparia, Kochia americana, Kochia californica, Kochia hirsuta, Kochia hyssopifolia, and/or Kochia prostrata; in particular Kochia scoparia).

Preferably, in the second and/or third aspects of the invention, the method is for controlling and/or inhibiting the growth of dicotyledonous and/or broadleaf weeds (or weeds of the genus Kochia), and is also a method for controlling and/or inhibiting the growth of monocotyledonous (preferably grassy) weeds.

In all aspects of the invention mentioned hereinabove or hereinbelow, independently, preferably, the liquid herbicidal composition is applied, at a time after emergence of the weeds, at an application rate of from 15 to 90 g/ha or preferably from 30 to 60 g/ha (more preferably 45 to 60 g/ha, most preferably 60 g/ha) of pinoxaden, and at an application rate of from 70 to 250 g/ha (more preferably from 70 to 160 g/ha or from 80 to 140 g/ha, still more preferably from 90 to 120 g/ha or from 100 to 110 g/ha, most preferably 105 g/ha) of fluoroxypyr “acid equivalent”. The application of 60 g/ha of pinoxaden and 105 g/ha of fluoroxypyr “acid equivalent” is thought to be ideal, e.g. on crops of non-oat cereals (e.g. wheat and/or barley) and/or e.g. for use in USA and/or Canada.

Preferred features of the first, second and/or third aspects of the invention are as follows. These preferred features also generally apply to the fourth and/or fifth aspects of the present invention as described hereinafter, with all necessary changes having been made.

Alkyl and alkoxyalkyl groups, e.g. within the phosphate and/or phosphonate adjuvant and/or within any fluoroxypyr ester groups and/or within the ester groups of any further (non-pinoxaden) herbicides, can be straight-chain (linear) or branched. Where two or three or more alkyl and/or alkoxyalkyl groups are present within the phosphate and/or phosphonate adjuvant, these can be the same or different.

Preferably, the C₁-C₁₂alkyl ester or 2-(C₁-C₆alkoxy)C₂-C₄alkyl-ester of fluoroxypyr is a C₅-C₁₀alkyl or 2-(C₂-C₆alkoxy)C₂-C₃alkyl-ester of fluoroxypyr, more preferably a C₆-C₁₀alkyl ester or a C₂-C₅alkoxy-CH₂—CH(Me)-ester or a 2-(C₂-C₅alkoxy)-ethyl-ester of fluoroxypyr, still more preferably a C₈alkyl ester or a C₄alkoxy-CH₂—CH(Me)-ester of fluoroxypyr. Most preferably, the ester of fluoroxypyr is the 1-methylheptyl (“meptyl”) ester of fluoroxypyr, (named fluoroxypyr-meptyl), or the 2-butoxy-1-methylethyl ester of fluoroxypyr (named fluoroxypyr-2-butoxy-1-methylethyl).

In all aspects of the invention mentioned hereinabove or hereinbelow, independently, preferably, the liquid (or first) herbicidal composition (e.g. EC) comprises from 0.5% to 30% pinoxaden, preferably from 1% to 20%, most preferably from 2% to 10%, e.g. from 2.5% to 7%, e.g. about 4-5%, by weight of the liquid (or first) herbicidal composition (e.g. EC).

In all aspects of the invention mentioned hereinabove or hereinbelow, independently, preferably, the liquid (or first) herbicidal composition (e.g. EC) comprises from 1% to 40% of the ester of fluoroxypyr (measured as the ester), preferably from 2% to 30%, most preferably from 4% to 20%, e.g. from 7% to 15%, e.g. from 10 to 15%, by weight of the liquid (or first) herbicidal composition (e.g. EC).

In all aspects of the invention mentioned hereinabove or hereinbelow, independently, in the liquid herbicidal composition, preferably the weight ratio of the pinoxaden to the ester of fluoroxypyr (calculated as the equivalent amount of fluoroxypyr free carboxylic acid, i.e. calculated as the fluoroxypyr “acid equivalent” (AE)) is: from 60:70 to 60:250, more preferably from 60:70 to 60:160, still more preferably from 60:80 to 60:140, even more preferably from 60:90 to 60:120, yet more preferably from 60:100 to 60:110, or most preferably is 60:105.

The most preferred 60:105 weight ratio, of the pinoxaden to the ester of fluoroxypyr (calculated as fluoroxypyr acid equivalent), allows the liquid herbicidal composition to be applied (typically post-emergence) at the preferred application rate of 60 g/ha pinoxaden and 105 g/ha of fluoroxypyr acid equivalent, which is thought to be ideal for USA and Canada.

For the built-in phosphate and/or phosphonate adjuvant, preferably, the tris-ester of phosphoric acid is a tris-[C₈-C₁₀alkyl or 2-(C₂-C₆alkoxy)ethyl-]ester of phosphoric acid, in particular a tris-[C₈alkyl or 2-(C₄alkoxy)ethyl-]ester of phosphoric acid. More preferably, the tris-ester of phosphoric acid is tris-(2-ethylhexyl) phosphate, tris-n-octyl phosphate and/or tris-[2-(n-butoxy)ethyl]phosphate; most preferably tris-(2-ethylhexyl) phosphate (whose abbreviation is TEHP).

For the built-in phosphate and/or phosphonate adjuvant, preferably, the bis-ester of the C₃-C₁₂alkyl-phosphonic acid is a bis-(C₄-C₁₀alkyl) ester of a C₄-C₁₀alkyl-phosphonic acid, in particular a bis-(C₄-C₈alkyl) ester of a C₄-C₈alkyl-phosphonic acid. More preferably, the bis-ester of the C₃-C₁₂alkyl-phosphonic acid is: bis-(2-ethylhexyl) (2-ethylhexyl)phosphonate, bis-(2-ethylhexyl) (n-octyl)phosphonate and/or di-n-butyl (n-butyl)phosphonate; most preferably bis-(2-ethylhexyl) (n-octyl)phosphonate.

Preferably, the built-in phosphate and/or phosphonate adjuvant comprises (e.g. consists essentially of) tris-(2-ethylhexyl) phosphate, tris-n-octyl phosphate, tris-[2-(n-butoxy)ethyl]phosphate, bis-(2-ethylhexyl) (2-ethylhexyl)phosphonate, bis-(2-ethylhexyl) (n-octyl)phosphonate and/or di-n-butyl (n-butyl)phosphonate.

Preferably, the built-in phosphate and/or phosphonate adjuvant is a built-in phosphate adjuvant.

Most preferably, the built-in phosphate and/or phosphonate adjuvant comprises (e.g. consists essentially of) tris-(2-ethylhexyl) phosphate (whose abbreviation is TEHP).

Typically, the built-in phosphate and/or phosphonate adjuvant is present in from 5% to 70% by weight of the liquid (or first) herbicidal composition, but preferably it is present in from 10% to 60%, more preferably from 15% to 50%, still more preferably from 20% to 50% or from 20% to 45%, most preferably from 30% to 40%, by weight of the liquid (or first) herbicidal composition (e.g. EC).

The liquid (or first) herbicidal compositions (e.g. EC compositions) according to, or used in, the first, second and/or third aspects of the present invention are preferably stable with respect to pinoxaden chemical stability. The pinoxaden chemical stability is preferably as follows:
Preferably, the liquid (or first) herbicidal compositions (e.g. EC compositions) are characterized by a breakdown (loss) of no more than 5 weight % (preferably no more than 4 weight %, more preferably less than 2.5% which typically means less than 2.5 weight %) of the pinoxaden after 2 weeks storage at a temperature of 50° C.
Alternatively or additionally, preferably, the liquid (or first) herbicidal compositions (e.g. EC compositions) are characterized by a breakdown (loss) of no more than 5 weight % (preferably no more than 4 weight %, more preferably no more than 3 weight %) of the pinoxaden after 2 weeks storage at a temperature of 54° C.
Alternatively or additionally, preferably, the liquid (or first) herbicidal compositions (e.g. EC compositions) are characterized by a breakdown (loss) of no more than 4 weight % (preferably no more than 3 weight %, more preferably no more than 2.5 weight %) of the pinoxaden after 8 weeks storage at a temperature of 38° C.
Alternatively or additionally, preferably, the liquid (or first) herbicidal compositions (e.g. EC compositions) are characterized by a breakdown (loss) of no more than 13 weight % (preferably no more than 11 weight %, more preferably no more than 9 weight %) of the pinoxaden after 8 weeks storage at a temperature of 50° C.

Preferably, for maximum pinoxaden chemical stability when an alcohol solvent (e.g. THFA) is present, the composition (in particular the liquid (or first) herbicidal composition, typically in the form of an EC) contains substantially no (e.g. less than 0.1% w/w of, e.g. less than 0.01% w/w of, e.g. less than 0.001% w/w of, e.g. 0% of) acidic ingredient(s) which has/have a pKa of 4.0 or less or 3.5 or less (in particular 3.0 or less, e.g. 2.0 or less) when measured in water at 20 to 26° C. (more preferably at 25±1° C.).

Fluoroxypyr (free carboxylic acid) has a pKa of 2.94; see the Pesticide Manual 15^{th} edition, fluoroxypyr entry. Therefore, preferably, the composition (in particular the liquid (or first) herbicidal composition, typically in the form of an EC) contains substantially no (e.g. less than 0.1% w/w of, e.g. less than 0.01% w/w of, e.g. less than 0.001% w/w of, e.g. 0% of) fluoroxypyr free carboxylic acid.

Preferably, for maximum pinoxaden chemical stability when an alcohol solvent (e.g. THFA, see later) is present, the composition (in particular the liquid (or first) herbicidal composition, typically in the form of an EC) contains substantially no (e.g. less than 0.1% w/w of, e.g. less than 0.01% w/w of, e.g. less than 0.001% w/w of, e.g. 0% of) strongly basic ingredient(s) whose conjugate acid(s) has/have a pKa of 10 or more (in particular 9 or more, in particular 8 or more) when measured in water at 20 to 26° C. (more preferably at 25±1° C.).

Preferably, e.g. for maximum pinoxaden chemical stability, the liquid (or first) herbicidal composition, e.g. in the form of an emulsifiable concentrate (EC), contains substantially no water (in particular less than 1% w/w of water, more particularly less than 0.5% w/w, e.g. equal to or less than 0.2% w/w, e.g. less than 0.1% w/w of water).

Preferably, the liquid (or first) herbicidal composition (e.g. emulsifiable concentrate, EC) comprises one, two or more agriculturally-acceptable organic solvents.

Preferably, the liquid (or first) herbicidal composition (e.g. EC) comprises a heavy aromatic hydrocarbon solvent, typically a mixture of heavy aromatic hydrocarbons. More preferably, the heavy aromatic hydrocarbon solvent comprises a mixture of naphthalenes substituted by alkyl(s), wherein the alkyl(s) contain 1, 2, 3 or 4 or more (e.g. 1, 2, 3 or 4) carbon atoms in total. Still more preferably, the naphthalenes substituted by alkyl(s) are present in a total of from 50% to 100%, preferably from 65% to 99%, more preferably from 75% to 97%, by weight of the heavy aromatic hydrocarbon solvent. Preferably, the heavy aromatic hydrocarbon solvent has a low content of naphthalene (i.e. unsubstituted naphthalene); and more preferably contains from 0% to 2% or from 0% to 1% of naphthalene, more preferably from 0.01% to 1% of naphthalene, such as from 0.05% to 0.7% of naphthalene, by weight of the heavy aromatic hydrocarbon solvent.

The heavy aromatic hydrocarbon solvent is typically present in from 8% to 50% by weight of the liquid (or first) herbicidal composition, but preferably it is present in from 10% to 45% or from 15% to 40%, more preferably from 15% to 35%, e.g. from 20% to 30%, by weight of the liquid (or first) herbicidal composition (e.g. EC).

Preferably, the liquid (or first) herbicidal composition (e.g. EC) comprises an alcohol solvent,

wherein the alcohol solvent comprises (e.g. consists essentially of, in particular comprises, by weight of the alcohol solvent, 96% or more of, or 98% or more of): tetrahydrofurfuryl alcohol [THFA, also named (tetrahydrofuran-2-yl)methanol], 2-methyl-pentane-2,4-diol (also named hexylene glycol), 4-hydroxy-4-methyl-pentane-2-one (also named diacetone alcohol), benzyl alcohol, 2-ethylhexanol, n-octanol, cyclohexanol, lactic acid methyl ester, lactic acid butyl ester, benzyl lactate, or a mixture of two or more of these alcohols. Preferably, the alcohol solvent comprises (e.g. consists essentially of) tetrahydrofurfuryl alcohol, 2-methyl-pentane-2,4-diol (hexylene glycol), 4-hydroxy-4-methyl-pentane-2-one (diacetone alcohol), or a mixture of two or more of these alcohols. Most preferably the alcohol solvent comprises (e.g. consists essentially of, in particular comprises, by weight of the alcohol solvent, 96% or more of, or 98% or more of) tetrahydrofurfuryl alcohol (THFA).

The alcohol solvent [e.g. comprising tetrahydrofurfuryl alcohol, 2-methyl-pentane-2,4-diol, 4-hydroxy-4-methyl-pentane-2-one, or a mixture of two or more of these alcohols] is typically present in from 5% to 50% or from 8% to 40% by weight of the liquid (or first) herbicidal composition; but more preferably it is present in from 15% to 40% or from 16% to 40%, still more preferably from 15% to 30% or from 16% to 30%, most preferably from 16% to 24%, by weight of the liquid (or first) herbicidal composition (e.g. EC).

In one preferable embodiment, the alcohol solvent comprises tetrahydrofurfuryl alcohol [THFA, also named (tetrahydrofuran-2-yl)methanol], preferably present in 50% or more by weight of the alcohol solvent. More preferably, the alcohol solvent consists essentially of tetrahydrofurfuryl alcohol; still more preferably, the alcohol solvent comprises, by weight of the alcohol solvent, 96% or more of, or 98% or more of tetrahydrofurfuryl alcohol. Yet more preferably, in this preferred embodiment, the alcohol solvent comprising tetrahydrofurfuryl alcohol contains substantially none (such as from 0 to 2.0%, preferably from 0 to 1.0%, more preferably from 0 to 0.5% or from 0 to 0.3%, still more preferably from 0 to 0.1% or from 0 to 0.03% or from 0 to 0.01%, by weight of the alcohol solvent; most preferably none) of any solvent which has a C═O moiety (such as 4-hydroxy-4-methyl-pentane-2-one, lactic acid methyl ester, lactic acid butyl ester, or benzyl lactate); and, alternatively or additionally, more particularly, in this preferred embodiment, the alcohol solvent comprising THFA contains substantially none (such as from 0 to 2.0%, particularly from 0 to 1.0%, more particularly from 0 to 0.5% or from 0 to 0.3% or from 0 to 0.1%, by weight of the alcohol solvent; most particularly none) of any solvent which is 2-methyl-pentane-2,4-diol or benzyl alcohol. For example, in this preferred embodiment, a preferred tetrahydrofurfuryl alcohol-containing alcohol solvent, e.g. which is suitable for use in the herbicidal composition of or used in the invention, comprises, by weight of the alcohol solvent: 98.0% or more of tetrahydrofurfuryl alcohol, from 0 to 0.1% of furfuryl alcohol [i.e. (furan-2-yl)methanol], from 0 to 1.6% of 1,2-pentanediol, and from 0 to 0.3% of water; such a grade of tetrahydrofurfuryl alcohol is available e.g. from PennAKem (formerly Penn Specialty Chemicals, Inc.) e.g. at 3324 Chelsea Avenue, Memphis, Tenn. 38108, USA (www.pennakem.com) (also available in the Netherlands), or from Nova Molecular Technologies, Inc, Parker Place, Suite 725, Janesville, Wis. 53545, USA.

When the alcohol solvent comprises (e.g. consists essentially of) THFA, e.g. as in the In preferred and/or particular embodiments mentioned above, it is preferable that the alcohol solvent and/or the liquid (or first) herbicidal composition comprises a boron-based stabilizer. Preferably, the boron-based stabilizer acts as an antioxidant (e.g. to minimize peroxide formation in the THFA), and/or acts to neutralize at least part (i.e. part or all) of any acidic impurities that may be present in the herbicidal composition (e.g. to minimize chemical breakdown/loss of pinoxaden in the herbicidal composition).

Preferably, the boron-based stabilizer comprises (e.g. consists essentially of):

(a) a metal (M) borohydride (M⁺ BH₄⁻), more preferably a metal borohydride in which the metal is an alkali metal or an alkaline earth metal, such as sodium, lithium, potassium, magnesium or calcium borohydride, most preferably sodium borohydride NaBH₄; and/or
(b) a compound containing one or more tetrahedral (sp³ hybridized) boron atoms and one or more B—O bonds.

Note: The metal borohydride (a) (e.g. NaBH₄) is believed generally to slowly convert over time, e.g. to compound (b2) M⁺ B(H)ₙ(OR)ₘ⁻ mentioned below, in a tetrahydrofurfuryl-alcohol-containing liquid herbicidal composition.

Preferably, in the boron-based stabilizer, the compound (b) containing one or more tetrahedral (sp³ hybridized) boron atoms and one or more B—O bonds comprises (e.g. consists essentially of):

(b1) a metal borate; in particular comprising a metal tetrahydroxyborate (e.g. containing B(OH)₄⁻), a metal diborate (e.g. containing B₂O₅⁴⁻), a metal triborate (e.g. containing B₃O₇⁵⁻), a metal tetraborate (e.g. containing B₄O₇²⁻ and/or B₄O₉⁶⁻ and/or [B₄O₅(OH)₄]²⁻), or a metal metaborate (e.g. containing BO₂⁻); preferably in the metal borate the metal is an alkali metal or an alkaline earth metal, such as sodium, lithium, potassium, magnesium or calcium, in particular sodium or lithium; more preferably the metal borate comprises (e.g. is) a metal tetraborate such as sodium or lithium tetraborate, most preferably sodium tetraborate (“borax”), such as sodium tetraborate anhydrate or preferably hydrate (e.g. decahydrate); and/or
(b2) a compound of formula M⁺ B(H)ₙ(OR)ₘ⁻ wherein M is a metal (preferably an alkali metal or an alkaline earth metal, e.g. sodium, lithium, potassium, magnesium or calcium, preferably sodium), n is 0, 1, 2, or 3, m is 1, 2, 3 or 4 and n+m is 4, and wherein each OR group, independently of any other OR group, is C₁-C₈alkoxy (e.g. methoxy, ethoxy, 2-ethylhexyloxy or n-octyloxy), C₃-C₆cycloalkoxy such as cyclohexyloxy, (tetrahydrofuran-2-yl)methoxy (e.g. the deprotonated residue of THFA), benzyloxy, or phenoxy; preferably OR is (tetrahydrofuran-2-yl)methoxy.

Preferably, the boron-based stabilizer is present in the THFA-containing alcohol solvent in from 0.001% to 0.3% or from 0.002% to 0.3%, preferably from 0.001% to 0.1% or from 0.002% to 0.1%, more preferably from 0.002% to 0.05%, still more preferably from 0.004% to 0.03% (e.g. about 0.005% or about 0.015%), most preferably from 0.008% to 0.03% (e.g. about 0.015%), by weight of the alcohol solvent. Alternatively or additionally, preferably, the boron-based stabilizer is present in the liquid (or first) herbicidal composition (e.g. in a or the emulsifiable concentrate), in from 0.0002% to 0.06% or from 0.0004% to 0.06%, preferably from 0.0002% to 0.02% or from 0.0004% to 0.02%, more preferably from 0.0004% to 0.01%, still more preferably from 0.0008% to 0.006% (e.g. about 0.001% or about 0.003%), most preferably from 0.0016% to 0.006% (e.g. about 0.003%), by weight of the liquid (or first) herbicidal composition.

Preferably, the liquid (or first) herbicidal composition (e.g. EC) comprises a heavy aromatic hydrocarbon solvent (e.g. as described herein) and an alcohol solvent [e.g. as described herein, e.g. comprising tetrahydrofurfuryl alcohol, 2-methyl-pentane-2,4-diol, 4-hydroxy-4-methyl-pentane-2-one, or a mixture thereof]. The weight ratio of the heavy aromatic hydrocarbon solvent to the alcohol solvent is typically from 4:1 to 0.3:1, more typically from 3:1 to 0.5:1 or from 2.5:1 to 0.7:1 (see for example Formulation Examples 3 and 4A herein). However, in particular in order possibly to maximise the stability of the composition such as an EC, preferably, the weight ratio of the heavy aromatic hydrocarbon solvent to the alcohol solvent [e.g. comprising tetrahydrofurfuryl alcohol, 2-methyl-pentane-2,4-diol, 4-hydroxy-4-methyl-pentane-2-one, or a mixture thereof] is from 1.7:1 to 0.3:1 or from 1.7:1 to 0.5:1, more preferably from 1.5:1 to 0.5:1 or from 1.5:1 to 0.7:1, still more preferably from 1.35:1 to 0.8:1, e.g. from 1.25:1 to 1.0:1 (see for example Formulation Examples 1 and 4B herein).

The liquid (or first) herbidical composition of, or used in, the invention, especially for an emulsifiable concentrate, preferably comprises one or more emulsifiers. Preferably, the one or more emulsifiers comprise: a salt (e.g. an alkaline earth metal salt, e.g. a calcium salt) of a C₁-C₂₂alkyl-phenyl-sulfonate (e.g. a salt of a C₈-C₁₈alkyl-phenyl-sulfonate), such as calcium dodecylbenzenesulfonate (e.g. linear); a castor oil-alkylene oxide addition product (condensation product) (note: castor oil contains a triglyceride in which most of the fatty acid chains are ricinoleic acid which includes an OH group), in particular castor oil ethoxylate which can for example have varying amounts of ethoxylation, e.g. a castor oil ethoxylate (20 to 40 EO) (i.e. containing and/or produced using 20 to 40 moles of ethylene oxide (EO) per mole of castor oil) or preferably castor oil ethoxylate (30 EO); an alcohol-alkylene oxide addition product (condensation product), in particular a C₁-C₂₂alcohol-alkylene oxide addition product, such as a C₈-C₂₂alcohol ethoxylate (which can e.g. have varying amounts of ethoxylation) such as tridecyl alcohol ethoxylate; an alkylphenol-alkylene oxide addition product (condensation product), such as nonylphenol ethoxylate; a diC₁-C₂₂alkyl ester of a sulfosuccinate salt, such as sodium di(2-ethylhexyl)sulfosuccinate; a sorbitol ester, such as sorbitol oleate; a polyethylene glycol ester of a C₈-C₂₂fatty acid, such as polyethylene glycol stearate; a block copolymer of ethylene oxide (EO) and propylene oxide (PO); a butanol ethylene oxide (EO)/propylene oxide (PO) copolymer [i.e. or e.g. methyloxirane, polymer with oxirane, monobutyl ether], such as Atlas G-5000D™ butanol EO/PO copolymer (e.g. available from Croda); or a salt of a mono- and/or di-alkyl phosphate ester; or a mixture of two or more of these emulsifiers. Alternatively or additionally, one or more other emulsifiers can be used, preferably a tristyrylphenol alkoxylate such as a tristyrylphenol ethoxylate and/or a tristyrylphenol ethoxylate-propoxylate, more particularly a tristyrylphenol ethoxylate containing 8 to 30 (preferably 10 to 25) moles of ethylene oxide (EO) per mole of tristyrylphenol, such as Soprophor TS/10™ (10 moles EO), Soprophor BSU™ (16 moles EO), or Soprophor S/25™ (25 moles EO), all Soprophor™ tristyrylphenol alkoxylates being available from Rhodia, at 40 Rue de la Haie-Coq, 93306 Aubervilliers Cedex, France, and/or at Cranbury, N.J., USA); and/or one or more other emulsifier(s) as described e.g. in “McCutcheon's Detergents and Emulsifiers Annual”, MC Publishing Corp., Ridgewood, N.J., 1981. A mixture of two or more of any of these emulsifiers can also be used.

Typically, the one or more emulsifiers are present in a total of from 0.5% to 35%, preferably from 1% to 20% or from 2% to 20%, more preferably from 2% to 10%, still more preferably from 3% to 8%, by weight of the liquid (or first) herbicidal composition (e.g. EC).

Preferably, the liquid (or first) herbicidal composition contains an emulsifier which is a salt (e.g. an alkaline earth metal salt, in particular a calcium salt) of a C₁-C₂₂alkyl-phenyl-sulfonate, preferably a salt (e.g. an alkaline earth metal salt, in particular a calcium salt) of a C₈-C₁₈alkyl-phenyl-sulfonate, most preferably calcium dodecylbenzenesulfonate (e.g. linear); the salt of the C₁-C₂₂alkyl-phenyl-sulfonate is typically present in from 0.5% to 7.5%, preferably from 1% to 5%, more preferably from 2% to 3%, by weight of the liquid (or first) herbicidal composition (e.g. EC). More preferably, the liquid (or first) herbicidal composition contains an emulsifier which is: Rhodocal 60/BE™ calcium dodecylbenzenesulfonate (linear) (which typically has an about 60% content of active ingredient; typically commercially available from Rhodia (Cranbury, N.J., USA; or Aubervilliers Cedex, France; or Sao Paulo, Brazil; or Singapore)), or Nansa EVM63/B™ calcium dodecylbenzenesulfonate (linear); preferably Rhodocal 60/BE™.

Additionally or alternatively, preferably, the liquid (or first) herbicidal composition contains an emulsifier which is a castor oil-alkylene oxide addition product (condensation product), more preferably castor oil ethoxylate (preferably having 20 to 40 EO, more preferably 30 EO; i.e. containing and/or produced using 20 to 40 (preferably 30) moles of ethylene oxide (EO) per mole of castor oil); the castor oil-alkylene oxide addition product is typically present in from 1.5% to 10%, preferably from 2.5% to 7.5%, more preferably from 3% to 5%, by weight of the liquid (or first) herbicidal composition (e.g. EC). More preferably, additionally or alternatively, the liquid (or first) herbicidal composition contains an emulsifier which is:

(i) Alkamuls EL-620/LI™ castor oil ethoxylate (which typically has 30 EO), typically commercially available from Rhodia (Cranbury, N.J., USA; or Aubervilliers Cedex, France; or Sao Paulo, Brazil; or Singapore); or
(ii) Servirox OEG 59 E™ castor oil ethoxylate (which typically has about 30 EO, or, more specifically, 31 EO), typically commercially available from Elementis Specialties (Langestraat 167, 7491 AE Delden, The Netherlands).

In all aspects of the invention mentioned hereinabove or hereinbelow, independently, a preferred composition according to, or used in, the present invention comprises, by weight of the liquid (or first) herbicidal composition (e.g. EC):

(i) from 0.5% to 30% pinoxaden, preferably from 1% to 20%, most preferably from 2% to 10%, e.g. from 2.5% to 7%, e.g. about 4-5%;
(ii) from 1% to 40% of the ester of fluoroxypyr (measured as the ester), preferably from 2% to 30%, most preferably from 4% to 20%, e.g. from 7% to 15%, e.g. from 10 to 15%;
(iii) from 5% to 70% of built-in phosphate and/or phosphonate adjuvant, preferably from 10% to 60%, more preferably from 15% to 50%, still more preferably from 20% to 45%, most preferably from 30% to 40%;
(iv) from 0.5% to 35% of one or more emulsifiers, preferably from 1% to 20% or from 2% to 20%, more preferably from 2% to 10%, still more preferably from 3% to 8%;
(v) from 5% to 50% of alcohol solvent (the alcohol being selected from the list of alcohols disclosed herein, e.g. THFA, 2-methyl-pentane-2,4-diol, 4-hydroxy-4-methyl-pentane-2-one, or a mixture thereof); preferably from 8% to 40%, more preferably from 15% to 40%, still more preferably from 15% to 30%, most preferably from 16% to 24%; and
(vi) from 8% to 50% of heavy aromatic hydrocarbon solvent, preferably from 10% to 45% or from 15% to 40%, more preferably from 15% to 35%, e.g. from 20% to 30%;
and wherein the weight ratio of the pinoxaden to the ester of fluoroxypyr (calculated as the equivalent amount of fluoroxypyr free carboxylic acid, i.e. calculated as the fluoroxypyr “acid equivalent” (AE)) is: from 60:70 to 60:250, more preferably from 60:70 to 60:160, still more preferably from 60:80 to 60:140, even more preferably from 60:90 to 60:120, yet more preferably from 60:100 to 60:110, or most preferably is 60:105.

In all aspect of the present invention, it is strongly preferable that the liquid (or first) herbicidal composition according to, or used in, the present invention contains a safener. Preferably, the safener is selected from the group consisting of cloquintocet-mexyl, cloquintocet acid, mefenpyr-diethyl, cyprosulfamide, isoxadifen-ethyl and mixtures thereof; most preferably the safener is cloquintocet-mexyl. These safeners are known and are described, for example, in The Pesticide Manual, 15^{th} Edition, British Crop Protection Council, 2009 or other readily available resources. Preferably, the safener (e.g. cloquintocet-mexyl) is present in from 0.1% to 10%, preferably from 0.5% to 5%, more preferably from 0.5% to 3%, e.g. from 0.7% to 2%, e.g. from 1.0% to 1.5%, by weight of the liquid (or first) herbicidal composition (e.g. EC). Typically, the weight ratio of the pinoxaden to the safener, in particular the weight ratio of the pinoxaden to the [cloquintocet-mexyl or cloquintocet acid], is from 30:1 to 1:2, preferably from 20:1 to 1:1, more preferably from 8:1 to 2:1, most preferably 4:1.

Optionally, clodinafop-propargyl (a further herbicide, suitable for controlling grassy weeds), can also be incorporated into the liquid (or first) herbicidal compositions (e.g. EC's) according to, or used in, the present invention. Clodinafop-propargyl can for example be present in from 0.5% to 10%, e.g. from 1% to 5%, of the liquid (or first) herbicidal composition (e.g. EC).

The herbicidal compositions of, or used in, the invention can optionally comprise one or more additional formulation aids known in the art such as: viscosity-modifying substances (in particular thickeners), crystallisation inhibitors, suspending agents, dyes, anti-oxidants, foaming agents, light absorbers, mixing aids, anti-foams, complexing agents, neutralising or pH-modifying substances and buffers, corrosion-inhibitors, fragrances, wetting agents, absorption improvers, micronutrients, plasticisers, glidants, lubricants, dispersants, anti-freezes, and/or microbiocides.

Preferably, the liquid (or first) herbicidal composition according to, or used in, the present invention is in the form of an emulsifiable concentrate (EC), an oil dispersion (OD), a dispersible concentrate (DC), a suspo-emulsion (SE), or a microemulsifiable concentrate; in particular an emulsifiable concentrate (EC), an oil dispersion (OD), or a dispersible concentrate (DC). However, it is also possible, though less preferable, that the composition is present in the form of a gel, an emulsion in water (EW) such as an oil-in-water emulsion, an oil flowable (a spreading oil), an aqueous dispersion or a capsule suspension, or in another liquid form e.g. such as those known, for example, from the Manual on Development and Use of FAO Specifications for Plant Protection Products, 5th Edition, 1999.

Most preferably, the liquid (or first) herbicidal composition according to, or used in, the present invention is in the form of an emulsifiable concentrate (EC).

The liquid (or first) herbicidal composition can either be applied, e.g. to the weeds and/or to the locus thereof e.g. the field, directly or more usually can be diluted prior to use, e.g. by diluting with an agriculturally-acceptable aqueous solvent (such as water) which is suitable for spraying onto a field. A diluted, typically aqueous, herbicidal composition can be prepared, for example, by mixing (e.g. tank-mixing) with water, a liquid fertiliser, a micro-nutrient, a biological organism, an oil and/or or another solvent; in particular by mixing (e.g. tank-mixing) with water.

The formulations (compositions) can be prepared, for example, by mixing the active ingredients (e.g. the pinoxaden and the fluoroxypyr ester, and preferably also a safener) with the “inert” (i.e. not herbicidally active) formulation ingredients, in order to obtain compositions e.g. in the form of concentrates, solutions, dispersions and/or emulsions.

A fourth aspect of the invention provides a liquid herbicidal composition, comprising a mixture of:

(i) pinoxaden;
(ii) a C₁-C₁₂alkyl ester or a 2-(C₁-C₆alkoxy)C₂-C₄alkyl-ester of fluoroxypyr;
(iii) pyrasulfotole or an agriculturally-acceptable salt thereof; and
(iv) bromoxynil, or one or more C₄-C₁₂alkanoate esters thereof, or the butyrate ester thereof, or an agriculturally-acceptable base-addition salt thereof.

An embodiment of the composition of the fourth aspect of the invention was tested in US field trials (Biological Example 2 herein) as an diluted aqueous tank-mixed herbicidal composition comprising (A) an EC containing pinoxaden, fluoroxypyr-meptyl and TEHP (Formulation Example 1), and (B) a mixture of pyrasulfotole, bromoxynil octanoate and bromoxynil heptanoate (Huskie™, available from Bayer e.g. in US), and (C) ammonium sulfate (a spray adjuvant and/or tank-mix adjuvant). This tank-mixture showed excellent herbicidal efficacy versus a broad spectrum of broadleaf weeds, specifically weeds from the genus Salsola, Kochia, Chenopodium, Amaranthus, Descurainia, Helianthus, Lactuca, Polygonum/Fallopia and Solanum (see Biological Example 2 herein for results).

Preferably, in the fourth aspect of the invention, the one or more C₄-C₁₂alkanoate esters of bromoxynil are one or more C₆-C₁₀alkanoate esters of bromoxynil; more preferably the octanoate or heptanoate ester of bromoxynil or a mixture thereof; or most preferably a mixture of the octanoate and heptanoate esters of bromoxynil. Alternatively, the ester of bromoxynil can be the butyrate ester of bromoxynil. Preferably, in the fourth aspect of the invention, a salt of bromoxynil is a sodium or potassium (e.g. potassium) salt of bromoxynil.

A fifth aspect of the invention provides a liquid herbicidal composition, comprising a mixture of:

(i) pinoxaden;
(ii) a C₁-C₁₂alkyl ester or a 2-(C₁-C₆alkoxy)C₂-C₄alkyl-ester of fluoroxypyr;
(iii) MCPA, or a C₁-C₁₂alkyl ester or a 2-(C₁-C₆alkoxy)C₂-C₄alkyl-ester thereof, or an agriculturally-acceptable base-addition salt thereof; and
(iv) a fourth herbicide which is: florasulam, prosulfuron, triasulfuron, or an agriculturally-acceptable base-addition salt of any of these.

An embodiment of the composition of the fifth aspect of the invention was tested in US field trials (Biological Example 2 herein) as three different diluted aqueous tank-mixed herbicidal compositions comprising:

(A) an EC containing pinoxaden, fluoroxypyr-meptyl and TEHP (Formulation Example 1), and (D) MCPA or an ester or salt thereof; either (a) as a premix with florasulam (Orion™), or (b) as a tank-mix with prosulfuron (Peak™), or (c) as a tank-mix with triasulfuron (Amber™). These three tank-mixtures showed excellent herbicidal efficacy versus a broad spectrum of broadleaf weeds, specifically weeds from the genus Salsola, Kochia, Chenopodium, Amaranthus, Descurainia, Helianthus, Lactuca, Polygonum/Fallopia and Solanum (see Biological Example 2 herein for results).

The synthetic auxin herbicide MCPA [(4-chloro-2-methylphenoxy)acetic acid], and its herbicidal uses, are disclosed inter alia in “The Pesticide Manual”, ed. C. D. S. Tomlin, 15th edition, 2009, British Crop Production Council, UK, see entry 535 “MCPA” (pp. 709-712). MCPA, and/or salts thereof (e.g. sodium, potassium, dimethylammonium or isopropylammonium salt), and/or the 2-ethylhexyl ester of MCPA or 2-(n-butoxy)ethyl (i.e. butotyl) ester of MCPA, are known and/or are commercially available and/or are known for use in the post-emergence control of annual and/or perennial broad-leaved weeds; e.g. in the following crops: cereals, herbage seed crops, flax, rice, vines, peas, potatoes, asparagus, grassland, turf, under fruit trees; or on roadside verges or embankments; e.g. at application rates of from 280 to 2250 g active ingredient/ha, measured as the free acid (these features, e.g. uses or application rates can be used in the present invention). The structure of MCPA, and the two esters thereof, are shown below:

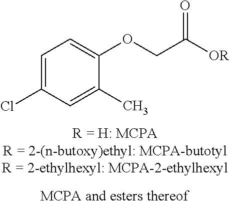

Therefore, preferably, in the fifth aspect of the invention, the C₁-C₁₂alkyl ester or 2-(C₁-C₆alkoxy)C₂-C₄alkyl-ester of MCPA is a C₅-C₁₀alkyl or 2-(C₂-C₆alkoxy)C₂-C₃alkyl-ester of MCPA, more preferably a C₆-C₁₀alkyl ester or a 2-(C₂-C₅alkoxy)-ethyl-ester or a C₂-C₅alkoxy-CH₂—CH(Me)-ester of MCPA, still more preferably a C₈alkyl ester or a 2-(C₄alkoxy)ethyl ester of MCPA. Most preferably, the ester of MCPA is the 2-ethylhexyl ester of MCPA (named MCPA-2-ethylhexyl), or the 2-(n-butoxy)ethyl ester of MCPA (named MCPA-2-butotyl). Preferably, in the fifth aspect, a salt of MCPA is a sodium, potassium, aluminium (e.g. see U.S. Pat. No. 5,462,915, Sandoz), dimethylammonium or isopropylammonium salt of MCPA.

An agriculturally-acceptable base-addition salt of florasulam, prosulfuron and/or triasulfuron can be, for example, a sodium or potassium salt of any of these three herbicides (or, for triasulfuron, an aluminium salt thereof).

The preferred aspects of the fourth and/or fifth aspects of the invention are as follows.

In the fourth and fifth aspects of the invention, preferably, the liquid herbicidal composition also comprises a built-in phosphate and/or phosphonate adjuvant; wherein the built-in phosphate and/or phosphonate adjuvant comprises a tris-[C₄-C₁₂alkyl or 2-(C₂-C₆alkoxy)C₂-C₄alkyl-]ester of phosphoric acid and/or a bis-(C₃-C₁₂alkyl) ester of a C₃-C₁₂alkyl-phosphonic acid. Preferred aspects of the built-in phosphate and/or phosphonate adjuvant are as disclosed elsewhere for the first, second and third aspects of the invention. Therefore, most preferably, in the fourth aspect, the built-in phosphate and/or phosphonate adjuvant is a built-in phosphate adjuvant, most preferably comprising (e.g. consisting essentially of) tris-(2-ethylhexyl) phosphate (whose abbreviation is TEHP).

In the fourth and fifth aspects of the invention, preferably, the liquid herbicidal composition is an aqueous (e.g. dilute aqueous) (e.g. tank-mixed) liquid herbicidal composition, more preferably a composition suitable for spraying onto a field. Typically, such an aqueous liquid herbicidal composition is in the form of an emulsion in water (e.g. oil-in-water emulsion) or a suspoemulsion. The aqueous liquid herbicidal composition embodiment of the fourth and fifth aspects of the invention is typically formed by mixing, e.g. in a container such as a tank:
one, two or more (preferably two or more) herbicidal compositions (e.g. liquid, typically comprising one, two or more emulsifiable concentrates) which are such that when mixed together they comprise all the active ingredients of the fourth and fifth aspects of the invention,
with an agriculturally-acceptable aqueous solvent which is a carrier suitable for field-spraying (preferably water).

See for example the third aspect of the invention herein for a suitable mixing and applying method.

Generally, unless started otherwise, the preferred aspects of the fourth and/or fifth aspects of the invention are the same as any relevant preferred aspects of the first, second and/or third aspects of the invention, with any necessary changes having been made.

In all aspects of the invention, for the following further herbicides, the typical application rates (typically applied after emergence of the weeds) are as follows. The typical ranges of weight ratios of any two of the following active ingredients can be calculated from the following typical application rates.

Typically, the pyrasulfotole or the agriculturally-acceptable salt thereof is applied at about 15 to about 70, or more typically about 20 to about 50 (preferably at about 30 to about 41, in particular 30 to 37.5) g/ha (measured as the salt-free compound). Pyrasulfotole is preferably used as a mixture with a safener, preferably mefenpyr-diethyl.

Typically, the bromoxynil or the ester or salt thereof is applied at about 70 to about 320 g/ha AE, more typically about 100 to about 250 g/ha AE, in particular about 120 to about 200 g/ha AE, e.g. about 135 to about 170 g/ha AE. AE=acid equivalent.

The MCPA or salt or ester thereof is typically applied at about 120 to about 700 g/ha AE, or more typically about 150 to about 500 g/ha AE, in particular about 200 to about 400 g/ha AE, e.g. about 250 to about 400 g/ha AE, or about 250 to about 350 g/ha AE. AE=acid equivalent.

The florasulam or salt thereof is typically applied at about 2 to about 10, or about 3 to about 10, preferably about 5, g/ha AE. AE=acid equivalent.

The prosulfuron or salt thereof is typically applied at about 5 to about 30, more typically about 5 to about 15 (preferably about 10) g/ha AE. AE=acid equivalent.

The triasulfuron or salt thereof is typically applied at about 5 to about 20, more typically about 5 to about 15 (preferably about 10 to about 15) g/ha AE. AE=acid equivalent.

Therefore, preferably, in the liquid herbicidal composition of the fourth (and/or other) aspect(s) of the invention, the weight ratios of the active ingredients are preferably as follows:
preferably, the weight ratio of the pyrasulfotole or the agriculturally-acceptable salt thereof (measured as the salt-free compound) to the ester of fluoroxypyr (calculated as the equivalent amount of fluoroxypyr free carboxylic acid, i.e. calculated as the fluoroxypyr “acid equivalent” (AE)) is: from 70:70 to 15:250 or from 50:70 to 20:250, more preferably from 70:70 to 15:160 or from 50:70 to 20:160, still more preferably from 50:80 to 20:140 or from 41:80 to 30:140, even more preferably from 41:90 to 30:120, yet more preferably from 41:100 to 30:110; and/or
preferably, the weight ratio of the bromoxynil or the ester or salt thereof (calculated as the bromoxynil “acid equivalent” (AE)) to the ester of fluoroxypyr (calculated as the equivalent amount of fluoroxypyr free carboxylic acid, i.e. calculated as the fluoroxypyr “acid equivalent” (AE)) is: from 320:70 to 70:250 or from 250:70 to 100:250, more preferably from 320:70 to 70:160 or from 250:70 to 100:160, still more preferably from 250:80 to 100:140 or from 200:80 to 120:140, even more preferably from 200:90 to 120:120 or from 170:90 to 135:120, yet more preferably from 170:100 to 135:110; and/or
preferably, the weight ratio of the pyrasulfotole or the agriculturally-acceptable salt thereof (measured as the salt-free compound) to the bromoxynil or the ester or salt thereof (calculated as the bromoxynil “acid equivalent” (AE)) is: from 70:70 to 15:320 or from 70:100 to 15:250, more preferably from 50:70 to 20:320 or from 50:100 to 20:250, still more preferably from 50:120 to 20:200 or from 41:120 to 30:200, even more preferably from 50:135 to 20:175 or from 41:135 to 30:175.

And also therefore, preferably, in the liquid herbicidal composition of the fifth (and/or other) aspect(s) of the invention, the weight ratios of the active ingredients are preferably as follows:
preferably, the weight ratio of the MCPA or the ester or salt thereof (calculated as the MCPA “acid equivalent” (AE)) to the ester of fluoroxypyr (calculated as the equivalent amount of fluoroxypyr free carboxylic acid, i.e. calculated as the fluoroxypyr “acid equivalent” (AE)) is: from 700:70 to 120:250 or from 500:70 to 150:250, more preferably from 700:70 to 120:160 or from 500:70 to 150:160, still more preferably from 500:80 to 150:140 or from 400:80 to 200:140, even more preferably from 400:90 to 200:120 or from 400:90 to 250:120, yet more preferably from 400:100 to 250:110 or from 350:100 to 250:110; and/or
preferably, the weight ratio of the florasulam or the salt thereof (calculated as the florasulam “acid equivalent” (AE)) to the ester of fluoroxypyr (calculated as the equivalent amount of fluoroxypyr free carboxylic acid, i.e. calculated as the fluoroxypyr “acid equivalent” (AE)) is: from 10:70 to 2:250 or from 10:70 to 3:250, more preferably from 10:70 to 2:160 or from 10:70 to 3:160 or from 5:70 to 5:160, still more preferably from 10:80 to 3:140 or from 5:80 to 5:140, even more preferably from 10:90 to 3:120 or from 5:90 to 5:120, yet more preferably from 5:100 to 5:110; and/or
preferably, the weight ratio of the prosulfuron or the salt thereof (calculated as the prosulfuron “acid equivalent” (AE)) to the ester of fluoroxypyr (calculated as the equivalent amount of fluoroxypyr free carboxylic acid, i.e. calculated as the fluoroxypyr “acid equivalent” (AE)) is: from 30:70 to 5:250 or from 15:70 to 5:250, more preferably from 30:70 to 5:160 or from 15:70 to 5:160 or from 10:70 to 10:160, still more preferably from 15:80 to 5:140 or from 10:80 to 10:140, even more preferably from 15:90 to 5:120 or from 10:90 to 10:120, yet more preferably from 10:100 to 10:110; and/or
preferably, the weight ratio of the triasulfuron or the salt thereof (calculated as the triasulfuron “acid equivalent” (AE)) to the ester of fluoroxypyr (calculated as the equivalent amount of fluoroxypyr free carboxylic acid, i.e. calculated as the fluoroxypyr “acid equivalent” (AE)) is: from 20:70 to 5:250 or from 15:70 to 5:250, more preferably from 20:70 to 5:160 or from 15:70 to 5:160 or from 15:70 to 10:160, still more preferably from 15:80 to 5:140 or from 15:80 to 10:140, even more preferably from 15:90 to 5:120 or from 15:90 to 10:120, yet more preferably from 15:100 to 10:110.

Another aspect of the invention provides a method for controlling and/or inhibiting the growth of weeds (in particular dicotyledonous and/or broadleaf weeds), comprising applying a liquid herbicidal composition, according to or as described or used in any aspect of the present invention (e.g. a herbicidally effective amount thereof), to the weeds or to the locus thereof, at a time after emergence of the weeds.

In all aspects of the invention, the weeds to be controlled and/or growth-inhibited may be monocotyledonous (preferably grassy) weeds, and/or dicotyledonous and/or broadleaf weeds.

In all aspects of the invention, monocotyledonous (preferably grassy) weeds, e.g. to be controlled and/or growth-inhibited (e.g. by the pinoxaden), typically comprise (e.g. are) weeds from the genus Alopecurus, Apera, Avena, Echinochloa, Lolium, Phalaris and/or Setaria; in particular: Alopecurus myosuroides (English name “blackgrass”), Avena fatua (English name “wild oats”), Avena sativa (English name “oats” (volunteer)), Echinochloa crus-galli (English name “common barnyard grass”), Lolium perenne (English name “perennial ryegrass”), Lolium multiflorum (English name “Italian ryegrass”), Lolium persicum (English name “Persian darnel”), Lolium rigidum, Setaria viridis (English name “green foxtail”), Setaria faberi (English name “giant foxtail”) and/or Setaria lutescens (English name “yellow foxtail”). In non-oat cereal crops such as wheat and/or barley, control and/or growth inhibition of weeds from the genus Alopecurus, Apera, Avena, especially Avena fatua, Lolium, and/or Setaria is preferred; in particular Avena (especially Avena fatua) and/or Setaria (especially Setaria viridis, Setaria lutescens and/or Setaria faberi), e.g. in the US and/or Canada. The grassy weeds can alternatively or additionally comprise weeds from the genus Panicum such as Panicum miliaceum (English name “wild proso millet”).

In all aspects of the invention, dicotyledonous and/or broadleaf weeds, e.g. to be controlled and/or growth-inhibited (e.g. by the fluoroxypyr ester), in particular comprise (e.g. are) weeds from the genus Kochia, Polygonum, Fallopia, Salsola, Descurainia, Helianthus, Lactuca, Solanum, Sinapsis, Amaranthus, Brassica, Chenopodium, Fagopyrum, Eriogonum, Convolvulus, Chrysanthemum, Cirsium, Matricaria, Galium (e.g. Galium aparine, English name “catchweed bedstraw”), Papaver, Stellaria, Viola and/or Veronica; and/or can in particular comprise (e.g. be) weeds from the genus Xanthium (e.g. Xanthium strumarium, English name “common cocklebur”), Linum (e.g. Linum usitatissimum, English name “volunteer flax”), and/or Ambrosia (e.g. Ambrosia artemisiifolia, English name “common ragweed”).

Preferably, the dicotyledonous and/or broadleaf weeds, e.g. to be controlled and/or growth-inhibited (e.g. by the fluoroxypyr ester), comprise (e.g. are) weeds from the genus Kochia, Polygonum, Fallopia, Salsola, Descurainia, Helianthus, Lactuca, Solanum, Sinapsis, Amaranthus, Brassica, Chenopodium and/or Fagopyrum; in particular Kochia scoparia (English names “kochia”, “goldcrest kochia”, “ragweed”, “summer cypress”, “fireball”, “Mexican fireweed”), Kochia americana (English name “green molly”), Kochia californica (English name “rusty molly”), Kochia hirsuta (English name “hairy smotherweed”), Kochia hyssopifolia (English name “fivehorn smotherweed”), Kochia prostrata (English name “forage kochia”), Polygonum convolvulus (also named Fallopia convolvulus; English name “wild buckwheat”), Fallopia japonica (English name “Japanese knotweed”), Salsola tragus (English name “Russian thistle”), Descurainia Sophia (English name “flixweed”), Helianthus (English name “sunflower”) such as Helianthus annuus (English name “common sunflower”), Lactuca serriola (English name “prickly lettuce”), Solanum physalifolium Rusby (English name “hairy nightshade”), Sinapsis, Amaranthus retroflexus (English name “redroot pigweed”), Brassica, Chenopodium (English name “lambsquarters”) such as Chenopodium album (English name “common lambsquarters”), and/or Fagopyrum esculentum (English name “common buckwheat”).

More preferably, the dicotyledonous and/or broadleaf weeds, e.g. to be controlled and/or growth-inhibited (e.g. by the fluoroxypyr ester), comprise (e.g. are) weeds from the genus Kochia, Polygonum, Fallopia, Salsola, Descurainia, Helianthus, Lactuca, Sinapsis and/or Amaranthus. Still more preferably, the dicotyledonous and/or broadleaf weeds, e.g. to be controlled and/or growth-inhibited (e.g. by the fluoroxypyr ester), comprise (e.g. are) weeds from the genus Kochia, Salsola, Descurainia, Helianthus, Lactuca and/or Sinapsis. Yet more preferably, dicotyledonous and/or broadleaf weeds, e.g. to be controlled and/or growth-inhibited (e.g. by the fluoroxypyr ester), comprise (e.g. are) weeds from the genus Kochia, Salsola, Descurainia and/or Helianthus.

Most preferably, the dicotyledonous and/or broadleaf weeds, e.g. to be controlled and/or growth-inhibited (e.g. by the fluoroxypyr ester), comprise (e.g. are) weeds from the genus Kochia (e.g. Kochia scoparia, Kochia americana, Kochia californica, Kochia hirsuta, Kochia hyssopifolia, and/or Kochia prostrata; in particular Kochia scoparia).

Typically, in all aspects of the invention, any monocotyledonous (preferably grassy) weeds (e.g. weeds from the genus Alopecurus, Apera, Avena, Echinochloa, Lolium, Phalaris and/or Setaria, and/or Panicum), e.g. to be controlled and/or growth-inhibited, are present in a density per weed genus of: up to 4000 plants/m², more typically from 3 to 3000 plants/m², still more typically from 8 to 2000 plants/m², such as from 10 to 500 plants/m² (low or medium density) and/or from 500 to 2000 plants/m² (high density); at the time of application of the liquid herbicidal composition. Preferably, any monocotyledonous (preferably grassy) weeds [e.g. weeds from the genus Alopecurus, Apera, Avena (e.g. Avena fatua), Echinochloa, Lolium, Phalaris and/or Setaria (especially Setaria viridis, Setaria lutescens and/or Setaria faberi), and/or Panicum], e.g. to be controlled and/or growth-inhibited, are at a growth stage of having 1-6 leaves on the main stem and prior to the emergence of the 4th tiller, or preferably are at a growth stage having 1-5 leaves on the main stem and prior to the emergence of the 3th tiller; at the time of application of the liquid herbicidal composition.

Typically, in all aspects of the invention, the weeds from the genus Kochia, Polygonum (e.g. Polygonum convolvulus), Fallopia, Salsola, Descurainia, Helianthus, Lactuca, Solanum, Sinapsis, Amaranthus, Brassica, Chenopodium and/or Fagopyrum, e.g. to be controlled and/or growth-inhibited, are

(i) present in a density per weed genus of: up to 1000 plants/m², more typically from 1 to 700 plants/m², still more typically from 2 to 500 plants/m², preferably from 4 to 500 or from 4 to 300 plants/m², such as from 4 to 30 plants/m² (low density) and/or from 30 to 250 plants/m² (medium density) and/or from 250 to 500 plants/m² (high density); at the time of application of the liquid herbicidal composition; and/or
(ii) have a height of up to 12 cm (in particular 0.5-12 cm or 1-10 cm), and/or have 1-20 leaves such as 1-14 or 2-14 leaves (e.g. for Kochia), and/or have 1-6 or 1-5 or 1-4 leaves (e.g. for Polygonum and/or Fallopia, and/or more particularly Helianthus and/or Lactuca); at the time of application of the liquid herbicidal composition.

More typically, in all aspects of the invention, when the weeds are from the genus Kochia, Polygonum, Fallopia, Salsola, Descurainia, Solanum, Sinapsis, Amaranthus, Brassica, Chenopodium and/or Fagopyrum then they have a height of up to 12 cm (in particular 0.5-12 cm or 1-10 cm), at the time of application of the liquid herbicidal composition; and when the weeds are from the genus Helianthus and/or Lactuca then they have 1-5 leaves (in particular 1-4 leaves), at the time of application of the liquid herbicidal composition.

Preferably, in all aspects of the invention, the weeds from the genus Kochia (e.g. Kochia scoparia), e.g. to be controlled and/or growth-inhibited, have a height of up to 12 cm (preferably 0.5-12 cm or 1-10 cm) and/or have 1-20 leaves such as 1-14 or 2-14 leaves; at the time of application of the liquid herbicidal composition. The weeds from the genus Kochia (e.g. Kochia scoparia), e.g. to be controlled and/or growth-inhibited, are typically present in a density of up to 1500 plants/m², more typically from 1 to 1000 plants/m², preferably from 10 to 700 plants/m², more preferably from 25 to 700 plants/m², such as from 35 to 250 plants/m² (medium density) and/or from 250 to 700 or from 250 to 600 plants/m² (high density); at the time of application of the liquid herbicidal composition. In Canadian field trial 1 within Biological Example 3 herein, greater control of an initially high density of 300 to 500 plants/m² of Kochia scoparia was seen at 30 days after application of herbicide with Formulation Example 1 (60% control), which is a specific EC composition of pinoxaden, fluoroxypyr-meptyl and a built-in phosphate adjuvant (TEHP), compared to Starane™ (55% control), which is a fluoroxypyr EC composition. This evidence might possibly indicate that a liquid composition comprising pinoxaden, fluoroxypyr ester (e.g. fluoroxypyr-meptyl) and TEHP is or can be somewhat more effective at controlling/inhibiting the growth of high densities of weeds from the genus Kochia.

Preferably, in all aspects of the invention, the weeds from the genus Polygonum and/or Fallopia (e.g. Polygonum convolvulus, also named Fallopia convolvulus; English name “wild buckwheat”), e.g. to be controlled and/or growth-inhibited, have a height of up to 12 cm (preferably 0.5-12 cm or 1-10 cm) and/or have 1-6 or 1-5 leaves; at the time of application of the liquid herbicidal composition; and/or are present in a density per weed genus of: up to 1000 plants/m², more typically from 1 to 700 plants/m², still more typically from 2 to 500 plants/m², preferably from 4 to 500 or from 4 to 300 plants/m², in particular from 4 to 30 plants/m² (low density) and/or from 30 to 250 plants/m² (medium density) and/or from 250 to 500 plants/m² (high density); at the time of application of the liquid herbicidal composition.

In all aspects (e.g. in the methods) of the present invention, the herbicidal compositions (e.g. liquid herbicidal compositions) according to, or used in, the present invention are typically applied to crops of useful plants.

Crops of useful plants, on which the herbicidal compositions according to, or used in, the invention can be applied, include preferably non-oat cereals, in particular wheat (e.g. winter wheat, or spring wheat (also named summer wheat)), barley (e.g. winter barley, or spring barley (also named summer barley)), triticale, and/or rye.

The term “crops” is to be understood as also including crops that have been rendered tolerant to herbicides or classes of herbicides (for example ALS, GS, EPSPS, PPO and HPPD inhibitors) as a result of conventional methods of breeding or genetic engineering. An example of a crop that has been rendered tolerant e.g. to imidazolinones, such as imazamox, by conventional methods of breeding is Clearfield® summer rape (Canola). Examples of crops that have been rendered tolerant to herbicides by genetic engineering methods include e.g. glyphosate- and glufosinate-resistant maize varieties commercially available under the trade names RoundupReady® and LibertyLink®. Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt-176 maize hybrids of NK® (Syngenta Seeds). The Bt toxin is a protein that is formed naturally by Bacillus thuringiensis soil bacteria. Examples of toxins and transgenic plants able to synthesise such toxins are described in EP-A-451 878, EP-A-374 753, WO 93/07278, WO 95/34656, WO 03/052073 and EP-A-427 529. Examples of transgenic plants that contain one or more genes which code for an insecticidal resistance and express one or more toxins are KnockOut® (maize), Yield Gard® (maize), NuCOTIN33BC (cotton), Bollgard® (cotton), NewLeaf® (potatoes), NatureGard® and Protexcta®. Plant crops and their seed material can be resistant to herbicides and at the same time also to insect feeding (“stacked” transgenic events). Seed can, for example, have the ability to express an insecticidally active Cry3 protein and at the same time be glyphosate-tolerant. The term “crops” is to be understood as also including crops obtained as a result of conventional methods of breeding or genetic engineering which contain so-called output traits (e.g. improved flavour, storage stability, nutritional content).

Areas under cultivation, and/or the locus of weeds, and/or fields, are to be understood as including land where crop plants are already growing as well as land intended for the cultivation of those crop plants.

In all aspects of the invention, preferably, the liquid herbicidal composition is applied, at a time after emergence of the weeds, at an application rate of from 15 to 90 g/ha or preferably from 30 to 60 g/ha (more preferably 45 to 60 g/ha, most preferably 60 g/ha) of pinoxaden and at an application rate of from 70 to 250 g/ha (more preferably from 70 to 160 g/ha or from 80 to 140 g/ha, still more preferably from 90 to 120 g/ha or from 100 to 110 g/ha, most preferably 105 g/ha) of fluoroxypyr “acid equivalent”. The application of 60 g/ha of pinoxaden and 105 g/ha of fluoroxypyr “acid equivalent” is thought to be ideal, e.g. on crops of non-oat cereals (e.g. wheat and/or barley) and/or e.g. for use in USA and/or Canada.

The following Examples illustrate the invention further but do not limit the invention.

### FORMULATION EXAMPLE 1

### Emulsifiable Concentrate Containing Pinoxaden, Fluoroxypyr 1-Methylheptyl Ester and TEHP

An emulsifiable concentrate (EC) containing pinoxaden (CAS no. 243973-20-8) and fluoroxypyr 1-methylheptyl ester (CAS no. 81406-37-3) as herbicides, cloquintocet-mexyl as safener, and tris-(2-ethylhexyl) phosphate (TEHP) as a built-in adjuvant was prepared by mixing together the ingredients shown in Table 1 below in the stated percentages.

The detailed formulation manufacturing process is as follows:

1. Charge THFA (tetrahydrofurfuryl alcohol) and aromatic solvent into a mixing vessel, equipped with an agitator and a heating and cooling device. Mix until homogeneous.
2. Add castor oil ethoxylate and dodecyl-benzenesulfonic acid calcium salt. Mix until homogeneous.
3. Add cloquintocet-mexyl (Technical) and fluoroxypyr-1-methylheptyl ester (Technical). Mix until homogeneous.
4. Add TEHP and mix until homogeneous.
5. Add pinoxaden (Technical) and mix until homogeneous. Maintain the temperature in the vessel throughout the process always below 30° C.

Formulation Example 1 exhibited good stability, with respect to the chemical stability of the pinoxaden within it, at room temperature and at an elevated temperature. This contrasts with Formulation Example 3 hereinafter. See Formulation Example 4 hereinafter for chemical stability data of these and other compositions.

TABLE 1
(from Formulation Example 1)

| | Brand (trade | Intended | Concentration as % by |
|---|---|---|---|
| | mark), or grade, | function of | weight of composition |
| Ingredient | of ingredient | ingredient | (% w/w) |
| pinoxaden | | grassy-weed | 4.90% w/w |
| | | herbicide | |
| fluroxypyr 1-methylheptyl | | broadleaf-weed | 12.35% w/w (measured |
| ester | | herbicide | as actual weight of ester); |
| (fluroxypyr-meptyl) | | | equivalent to 8.58% |
| | | | w/w (when calculated as |
| | | | fluroxypyr free carboxylic |
| | | | acid; “acid equivalent”) |
| cloquintocet-mexyl | | safener | 1.23% w/w |
| calcium dodecylbenzene- | Rhodacal 60/B-E ™ | emulsifier | 2.0% w/w |
| sulfonate (linear) | | (ionic) | |
| castor oil ethoxylate (30 EO) | either (i) Alkamuls | emulsifier | 5.0% w/w |
| (condensation product of | EL-620/LI ™, or | (non-ionic) | |
| castor oil and ethylene oxide) | (ii) Servirox OEG | | |
| | 59 E ™ | | |
| tris-(2-ethylhexyl) phosphate | either (i) Synergen | built-in adjuvant | 33.33% w/w |
| (TEHP) | TEHP ™, or (ii) | | |
| | TRI-ISO- | | |
| | PHOSPHATE ™ | | |
| (tetrahydrofuran-2- | THFA-S, i.e. | solvent | 19.41% w/w |
| yl)methanol (tetrahydro- | THFA which has | | |
| furfuryl alcohol, THFA), | been stabilized with | | |
| stabilized with NaBH₄ | 150 ppm of NaBH₄ | | |
| | (0.015% by weight | | |
| | of THFA) | | |
| mixture of heavy aromatic | One of i), ii) or iii): | solvent | 21.78% w/w** |
| hydrocarbons with a low | i) Ultra Low | | |
| naphthalene content | Naphthalene | | |
| [e.g. from ca. 0.05% (or less) | Aromatic 200 ™ | | |
| to ca. 0.5% of naphthalene] | (from Exxon, USA); | | |
| | ii) Solvesso 200 ND ™ | | |
| | (Europe)*; or iii) | | |
| | Aromatic 200 | | |
| | Fluid ™ (ND) (from | | |
| | Exxon, USA) | | |

*Solvesso 200 ND ™ (available from Exxon, Europe) typically has a low percentage (e.g. ca. 0.5%) of naphthalene (ND = naphthalene depleted), and comprises also varying percentages of other (e.g. higher) aromatic hydrocarbons, and in particular typically comprises naphthalenes substituted by alkyl(s) wherein the alkyl(s) contain 1, 2, 3 or 4 (e.g. 1, 2 or 3) carbon atoms in total. By way of example only, certain batches of Solvesso 200 ND ™ have been measured as comprising, very approximately, the following ingredients: ca. 0.5% of naphthalene, ca. 14% to ca. 22% of 1-methyl-naphthalene, ca. 14% to ca. 32% of 2-methyl-naphthalene, ca. 21% to ca. 25% of C₂-naphthalene (i.e. molecules containing naphthalene + two additional carbon atoms, e.g. ethyl-naphthalene), ca. 9% to ca. 17% of C₃-naphthalene, 0% to ca. 11% of (C₄ and/or higher)-naphthalene(s), ca. 0.05% to ca. 0.5% of biphenyl, 0% to ca. 5% of C₄-benzene, and 0% to ca. 3% of C₅-benzene.
**Weight ratio of heavy aromatic hydrocarbon solvent to THFA solvent is 1.12:1.

### FORMULATION EXAMPLE 2

### Emulsifiable Concentrate Containing Pinoxaden and TEHP

An emulsifiable concentrate (EC) containing pinoxaden (CAS no. 243973-20-8) as the sole herbicide, cloquintocet-mexyl as safener, and tris-(2-ethylhexyl) phosphate (TEHP) as a built-in adjuvant was prepared by mixing together the ingredients shown in Table 2 below in the stated percentages.

TABLE 2
(from Formulation Example 2)

| | Brand (trade | Intended | Concentration as % by |
|---|---|---|---|
| | mark), or grade, | function of | weight of composition |
| Ingredient | of ingredient | ingredient | (% w/w) |
| pinoxaden | | grassy-weed | 5.05% w/w |
| | | herbicide | |
| cloquintocet-mexyl | | safener | 1.26% w/w |
| calcium dodecylbenzene- | typically: Nansa | emulsifier | 2.02% w/w |
| sulfonate (linear) | EVM63/B ™ | (ionic) | |
| castor oil ethoxylate (30 EO) | either (i) Alkamuls | emulsifier | 5.05% w/w |
| (condensation product of | EL-620/LI ™, or | (non-ionic) | |
| castor oil and ethylene oxide) | (ii) Servirox OEG | | |
| | 59 E ™ | | |
| tris-(2-ethylhexyl) phosphate | typically: Synergen | built-in adjuvant | 34.34% w/w |
| (TEHP) | TEHP ™ | | |
| (tetrahydrofuran-2- | THFA-S, i.e. | solvent | 18.18% w/w |
| yl)methanol (tetrahydro- | THFA which has | | |
| furfuryl alcohol, THFA), | been stabilized with | | |
| stabilized with NaBH₄ | 150 ppm of NaBH₄ | | |
| | (0.015% by weight | | |
| | of THFA) | | |
| mixture of heavy aromatic | can e.g. be i) or ii): | solvent | 34.10% w/w** |
| hydrocarbons, usually with a | i) Solvesso 200 ND ™ | | |
| low naphthalene content | (from Exxon, | | |
| [e.g. from ca. 0.05% (or less) | Europe)*; or ii) | | |
| to ca. 0.5% of naphthalene] | Aromatic 200 | | |
| | Fluid ™ (ND) (from | | |
| | Exxon, USA) | | |

*Solvesso 200 ND ™ (available from Exxon, Europe) typically has the ingredients mentioned at the end of Formulation Example 1, above.
**Weight ratio of heavy aromatic hydrocarbon solvent to THFA solvent is 1.88:1.

### FORMULATION EXAMPLE 3

### Emulsifiable Concentrate Containing Pinoxaden, Fluoroxypyr 1-Methylheptyl Ester and TEHP

An emulsifiable concentrate (EC) containing pinoxaden and fluoroxypyr 1-methylheptyl ester as herbicides, cloquintocet-mexyl as safener, and tris-(2-ethylhexyl) phosphate (TEHP) as a built-in adjuvant was prepared by mixing together the ingredients shown in Table 3 below in the stated percentages.

The detailed formulation manufacturing process is as follows:

1. Charge THFA (tetrahydrofurfuryl alcohol) and aromatic solvent into a mixing vessel, equipped with an agitator and a heating and cooling device. Mix until homogeneous.
2. Add castor oil ethoxylate, dodecyl-benzenesulfonic acid calcium salt, and butanol PO/EO copolymer. Mix until homogeneous.
3. Add cloquintocet-mexyl (Technical) and fluoroxypyr-1-methylheptyl ester (Technical). Mix until homogeneous.
4. Add TEHP and mix until homogeneous.
5. Add pinoxaden (Technical) and mix until homogeneous. Maintain the temperature in the vessel throughout the process always below 30° C.

Formulation Example 3 was found to be stable at room temperature for at least 6 months. However, at elevated temperatures, the chemical stability of the pinoxaden in the formulation was not as good as that of Formulation Example 1 (see Formulation Example 4 for data).

TABLE 3
(from Formulation Example 3)

| | Brand (trade | Intended | Concentration as % by |
|---|---|---|---|
| | mark), or grade, | function of | weight of composition |
| Ingredient | of ingredient | ingredient | (% w/w) |
| pinoxaden | | grassy-weed | 4.90% w/w |
| | | herbicide | |
| fluroxypyr 1-methylheptyl | | broadleaf-weed | 12.35% w/w (measured |
| ester | | herbicide | as actual weight of ester); |
| (fluroxypyr-meptyl) | | | equivalent to 8.58% |
| | | | w/w (when calculated as |
| | | | fluroxypyr free carboxylic |
| | | | acid; “acid equivalent”) |
| cloquintocet-mexyl | | safener | 1.23% w/w |
| calcium dodecylbenzene- | Rhodacal 60/B-E ™ | emulsifier | 3.0% w/w |
| sulfonate (linear) | | (ionic) | |
| castor oil ethoxylate (30 EO) | either (i) Alkamuls | emulsifier | 3.0% w/w |
| (condensation product of | EL-620/LI ™, or | (non-ionic) | |
| castor oil and ethylene oxide) | (ii) Servirox OEG | | |
| | 59 E ™ | | |
| butanol PO/EO copolymer | ATLAS G-5000D | emulsifier | 3.0% w/w |
| (methyloxirane, polymer with | | (non-ionic) | |
| oxirane, monobutyl ether) | | | |
| tris-(2-ethylhexyl) phosphate | either (i) Synergen | built-in adjuvant | 33.33% w/w |
| (TEHP) | TEHP ™, or (ii) TRI- | | |
| | ISO-PHOSPHATE ™ | | |
| (tetrahydrofuran-2- | THFA-S, i.e. THFA | solvent | 13.51% w/w |
| yl)methanol (tetrahydro- | which has been | | |
| furfuryl alcohol, THFA), | stabilized with 150 ppm | | |
| stabilized with NaBH₄ | of NaBH₄ | | |
| | (0.015% by weight | | |
| | of THFA) | | |
| mixture of heavy aromatic | One of i), ii) or iii): | solvent | 25.68% w/w** |
| hydrocarbons with a low | i) Ultra Low | | |
| naphthalene content | Naphthalene | | |
| [e.g. from ca. 0.05% (or less) | Aromatic 200 ™; | | |
| to ca. 0.5% of naphthalene] | ii) Solvesso 200 ND ™; | | |
| | or iii) Aromatic | | |
| | 200 Fluid ™ (ND) | | |

**Weight ratio of heavy aromatic hydrocarbon solvent to THFA solvent is 1.90:1.

### FORMULATION EXAMPLES 4A AND 4B

### Emulsifiable Concentrates Containing Pinoxaden, Fluoroxypyr 1-Methylheptyl Ester and TEHP

A number of emulsifiable concentrates (EC's) containing pinoxaden and fluoroxypyr 1-methylheptyl ester as herbicides, cloquintocet-mexyl as safener, tris-(2-ethylhexyl) phosphate (TEHP) as a built-in adjuvant, and (tetrahydrofuran-2-yl)methanol (tetrahydrofurfuryl alcohol, THFA) as one of the solvents, were prepared by mixing together the ingredients shown in Table 3A below in the stated percentages. The already-described compositions for Formulation Examples 1 and 3 are given again for comparison purposes.

TABLE 3A

| | | | Formulation | Formulation |
|---|---|---|---|---|
| | Formulation | Formulation | Example | Example |
| | Example 3 | Example 1 | 4A | 4B |
| | wt % of | wt % of | wt % of | wt % of |
| Ingredient | composition | composition | composition | composition |
| pinoxaden | 4.90 | 4.90 | 4.90 | 4.90 |
| fluroxypyr 1-methylheptyl ester | 12.35 | 12.35 | 12.35 | 12.35 |
| cloquintocet-mexyl | 1.23 | 1.23 | 1.23 | 1.23 |
| castor oil ethoxylate (30 EO), | 3.00 | 5.00 | 5.00 | 4.00 |
| surfactant (Alkamuls EL-620/LI ™) | | | | |
| calcium dodecylbenzene- | 3.00 | 2.00 | 2.00 | 2.00 |
| sulfonate, surfactant | | | | |
| (Rhodocal 60/BE ™) | | | | |
| butanol PO/EO copolymer, | 3.00 | — | — | 2.00 |
| surfactant (Atlas G-5000D ™) | | | | |
| TEHP | 33.33 | 33.33 | 33.33 | 33.33 |
| THFA solvent (which has been | 13.51 | 19.41 | 14.20 | 19.14 |
| stabilized with 150 ppm of NaBH₄) | | | | |
| heavy aromatic hydrocarbon | 25.68 | 21.78 | 26.99 | 21.05 |
| solvent (Aromatic 200ND ™) | | | | |
| total surfactant (weight % of the | 9.00 | 7.00 | 7.00 | 8.00 |
| composition) | | | | |
| weight ratio of heavy aromatic | 1.90:1 | 1.12:1 | 1.90:1 | 1.10:1 |
| hydrocarbon solvent to THFA | | | | |
| (alcohol) solvent | | | | |

### FORMULATION EXAMPLES 3, 1, 4A AND 4B

### Pinoxaden Chemical Stability within these Formulation Examples, at Elevated Temperatures

The chemical stability of pinoxaden, measured as percentage by weight loss of pinoxaden, within and for Formulation Examples 3, 1, 4A and 4B, after storage for 2 weeks at 54° C., after storage for 8 weeks at 38° C., and after storage for 8 weeks at 50° C., is given below.

| | Formu- | Formu- | Formulation | Formulation |
|---|---|---|---|---|
| weight % pinoxaden | lation | lation | Example | Example |
| loss after: | Example 3 | Example 1 | 4A | 4B |
| 2 weeks at 54° C. | 6.2 | 2.7 | 4.6 | 3.7 |
| 8 weeks at 38° C. | 5.3 | 2.1 | 3.9 | 2.7 |
| 8 weeks at 50° C. | 18.0 | 8.1 | 12.4 | 10.0 |

It can be seen that Formulation Examples 1 and 4B, which have an weight ratio of heavy aromatic hydrocarbon solvent to THFA (alcohol) solvent of 1.12:1 and 1.10:1 respectively, and both of which contain from 19 to 20 weight % of THFA solvent, have the best pinoxaden chemical stability at elevated temperatures.

### BIOLOGICAL EXAMPLE 1

### Glasshouse (Greenhouse) Experiment—Use of Pinoxaden and Fluoroxypyr Mixtures in the Control of Kochia scoparia

### BIOLOGICAL EXAMPLE 1

### Testing Methodology

Kochia scoparia (KCHSC), broadleaf weeds, are grown to the 4-10 leaf stage and to 1 to 2.5 inches (2.54 cm to 6.35 cm) in height, in a glasshouse.

Various test emulsifiable concentrate (EC) herbicidal compositions, as mentioned below and diluted with water as the carrier before application, were each applied post-emergence at five different application rates, by spraying onto Kochia scoparia at the above growth stage, using a spray volume of 100 L/ha.

The tested herbicidal compositions included the following, with the standard (1×) (maximum-tested) application rates mentioned for each:

(i) Formulation Example 1 (EC containing a “premix” of pinoxaden, fluoroxypyr 1-methylheptyl ester and TEHP), for which the standard (1×) application rate=165 g AE (acid equivalent)/ha, which includes 60 g/ha pinoxaden and 105 g AE (acid equivalent)/ha of fluoroxypyr.
(ii) Formulation Example 3 (EC containing a “premix” of pinoxaden, fluoroxypyr 1-methylheptyl ester and TEHP), for which the standard (1×) application rate=165 g AE (acid equivalent)/ha, which includes 60 g/ha pinoxaden and 105 g AE (acid equivalent)/ha of fluoroxypyr.
(iii) Formulation Example 2 (an EC containing pinoxaden and TEHP, for which the standard (1×) application rate=60 g/ha pinoxaden); tank-mixed (i.e. mixed at the diluted aqueous spray formulation stage) with Starane™ (an EC formulation of fluoroxypyr 1-methylheptyl ester, available from Dow AgroSciences, for which the standard (1×) application rate 105 g AE (acid equivalent)/ha of fluoroxypyr).
(iv) Starane™ alone (an EC formulation of fluoroxypyr 1-methylheptyl ester, available from Dow AgroSciences, for which the standard (1×) application rate 105 g AE (acid equivalent)/ha of fluoroxypyr).

The application rates tested for each of the above three tested herbicidal compositions were: the 1× rate(s), ½ of the 1× rate(s), ¼ of the 1× rate(s), ⅛ of the 1× rate(s), and 1/16 of the 1× rate(s), where the 1× rate(s) are mentioned above for each of the three compositions.

3 replicate tests were done for each treatment. Control of Kochia scoparia weeds were evaluated at 20-22 DAA (DAA=days after application of the herbicidal composition).

Linear regression was done of dose response curves to calculate ED90 values (effective dose for 90% control of Kochia scoparia) relative to the 1× application rate for each composition.

### BIOLOGICAL EXAMPLE 1

### Test Results

The activity of the test compositions on control of Kochia scoparia (KCHSC) is shown by presenting below dose estimates (application rate estimates) for fluoroxypyr (AE, acid equivalent), for responses of 90% control of KCHSC (at 22 DAA) on the absolute scale (ED90 values).

| | ED90, in g AE/ha of fluroxypyr |
|---|---|
| Test formulation | (and 95% confidence limits) |
| Formulation Example 1 | 41.944 (36.882-48.403) |
| Formulation Example 3 | 43.419 (37.970-50.489) |
| Formulation Example 2 tank- | 47.794 (42.609-54.329) |
| mixed with Starane ™ | |
| Starane ™ alone | 71.916 (61.295-87.043) |

### BIOLOGICAL EXAMPLE 1

### Results Summary

Formulation Example 1 (the EC “premix” of pinoxaden, fluoroxypyr 1-methylheptyl and TEHP), and the tank mixture of Formulation Example 2 (EC of pinoxaden+TEHP) and Starane™ (fluoroxypyr 1-methylheptyl) were statistically-significantly more active on Kochia scoparia (KCHSC) than Starane™ (fluoroxypyr 1-methylheptyl) alone.

Formulation Example 1 appeared to be slightly, but not statistically-significantly, more active against KCHSC than the tank mixture of Formulation Example 2 and Starane™.

### BIOLOGICAL EXAMPLE 2

### US Field Trial Results (5 Field Trials)

Five field trials were conducted in the summer in various US states, in wheat or barley fields, comparing inter alia the following, post-emergent application.

(i) Formulation Example 1 (an EC containing inter alia pinoxaden, fluoroxypyr-1-methylheptyl ester, and TEHP), applied at 165 g active ingredient/ha [60 g/ha pinoxaden+105 g/ha fluoroxypyr AE]; either alone or mixed with various broadleaf-weed herbicide tank-mix partners; and
(ii) a tank-mix of Starane (fluoroxypyr-meptyl, applied at 105 g/ha fluoroxypyr AE) mixed with Formulation Example 2 (an EC containing inter alia pinoxaden and TEHP, applied at 60 g/ha of pinoxaden).

Each of the tested herbicidal compositions (e.g. Formulation Example 1, Formulation Example 2, or others) was mixed with water before use, and were also, where necessary, tank-mixed with one or more further compositions containing one or more broadleaf-weed herbicides (e.g. Starane™ or other broadleaf-weed herbicides, as indicated in Table 4 below), to form a diluted aqueous herbicidal composition suitable for spraying.

Results:

The observed control of nine broadleaf weed species/genera, in wheat or barley fields, at 35 to 42 DAA (DAA=days after application of the herbicide) is shown in the two tables within Table 4 below.

TABLE 4
US field trial data from Biological Example 2

| | Russian | | | | |
|---|---|---|---|---|---|
| | thistle | kochia | lambs- | | |
| | (Salsola | (Kochia | quarters | redroot | |
| Herbicide(s) used; and total | tragus) | scoparia) | (Chenopodium) | pigweed | flixweed |
| compound application rate used | (average | (average | (average | (Amaranthus | (Descurainia |
| for each herbicide or herbicidal | of 5 | of 4 | of 3 | retroflexus) | sophia) |
| mixture | trials) | trials) | trials) | (1 trial) | (1 trial) |
| Formulation Example 2 (60 g/ha | 0 | 0 | 0 | 0 | 0 |
| pinoxaden) | | | | | |
| Formulation Example 1 (60 g/ha | 68.0 | 93.1 | 38.3 | 76.0 | 93.3 |
| pinoxaden + 105 g/ha fluroxypyr (AE)) | | | | | |
| Formulation Ex. 1 (60 g/ha pinoxaden + | 86.5 | 92.8 | 94.9 | 99.0 | 100 |
| 105 g/ha fluroxypyr (AE)) tank-mixed | | | | | |
| with Orion ™ 353 g/ha | | | | | |
| Formulation Ex. 1 (60 g/ha pinoxaden + | 92.5 | 91.2 | 93.8 | 99.7 | 100 |
| 105 g/ha fluroxypyr (AE)) tank-mixed | | | | | |
| with Weco Max ™ 473 g/ha | | | | | |
| Formulation Ex. 1 (60 g/ha pinoxaden + | 77.5 | 93.7 | 94.2 | 99.3 | 100 |
| 105 g/ha fluroxypyr (AE)) tank-mixed | | | | | |
| with Affinity TankMix ™ 21 g/ha | | | | | |
| Formulation Ex. 1 (60 g/ha pinoxaden + | 74.1 | 89.4 | 97.0 | 100 | 100 |
| 105 g/ha fluroxypyr (AE)) tank-mixed | | | | | |
| with MCPA 260 g/ha (AE) and Affinity | | | | | |
| TankMix ™ 10.5 g/ha | | | | | |
| Formulation Ex. 1 (60 g/ha pinoxaden + | 83.4 | 88.3 | 94.8 | 99.7 | 100 |
| 105 g/ha fluroxypyr (AED tank-mixed | | | | | |
| with Affinity BroadSpec ™ 14 g/ha | | | | | |
| Formulation Ex. 1 (60 g/ha pinoxaden + | 79.5 | 92.1 | 95.9 | 100 | 100 |
| 105 g/ha fluroxypyr (AE)) tank-mixed | | | | | |
| with MCPA 260 g/ha (AE) and Affinity | | | | | |
| BroadSpec ™ 7 g/ha | | | | | |
| Formulation Ex. 1 (60 g/ha pinoxaden + | 74.6 | 90.3 | 76.2 | 94.3 | 100 |
| 105 g/ha fluroxypyr (AE)) tank-mixed | | | | | |
| with Peak ™ 10 g/ha | | | | | |
| Formulation Ex. 1 (60 g/ha pinoxaden + | 91.5 | 90.4 | 95.3 | 99.3 | 100 |
| 105 g/ha fluroxypyr (AE)) tank-mixed | | | | | |
| with MCPA 260 g/ha (AE) and Peak ™ | | | | | |
| 10 g/ha | | | | | |
| Formulation Ex. 1 (60 g/ha pinoxaden + | 78.8 | 88.6 | 68.4 | 94.7 | 100 |
| 105 g/ha fluroxypyr (AE)) tank-mixed | | | | | |
| with Amber ™ 14.7 g/ha | | | | | |
| Formulation Ex. 1 (60 g/ha pinoxaden + | 86.2 | 93.4 | 92.3 | 99.7 | 100 |
| 105 g/ha fluroxypyr (AE)) tank-mixed | | | | | |
| with MCPA 260 g/ha (AE) + Amber ™ | | | | | |
| 14.7 g/ha | | | | | |
| Formulation Ex. 1 (60 g/ha pinoxaden + | 82.9 | 91.8 | 94.1 | 92.3 | 100 |
| 105 g/ha fluroxypyr (AED tank-mixed | | | | | |
| with Bronate Advanced ™ 420 g/ha | | | | | |
| Formulation Ex. 1 (60 g/ha pinoxaden + | 94.1 | 93.3 | 93.9 | 84.7 | 100 |
| 105 g/ha fluroxypyr (AE)) tank-mixed | | | | | |
| with Bison ™ 420 g/ha | | | | | |
| Formulation Ex. 1 (60 g/ha pinoxaden + | 95.0 | 94.9 | 93.1 | 100 | 100 |
| 105 g/ha fluroxypyr (AE)) tank-mixed | | | | | |
| with Huskie ™ 199 g/ha + ammonium | | | | | |
| sulfate | | | | | |
| Wolverine ™ 330 g/ha | 92.8 | 90.4 | 90.9 | 100 | 100 |
| Goldsky ™ 118 g/ha + non-ionic | 80.5 | 87.5 | 83.6 | 98.3 | 100 |
| surfactant (as adjuvant) | | | | | |
| Tank-mix of Formulation Example 2 | 63.9 | 91.1 | 26.1 | 50.0 | 80.0 |
| (60 g/ha pinoxaden) and Starane ™ | | | | | |
| (105 g/ha fluroxypyr (AE)) | | | | | |
| Tank-mix of Formulation Example 2 | 79.7 | 86.7 | 78.2 | 75.0 | 68.3 |
| (60 g/ha pinoxaden) and Widematch ™ | | | | | |
| 210 g/ha | | | | | |

| | | | | Hairy |
|---|---|---|---|---|
| | | Prickly | Wild | Nightshade |
| Herbicide(s) used; and total | Volunteer | Lettuce | Buckwheat | (Solanum |
| compound application rate used | Sunflower | (Lactuca | (Polygonum | physalifolium |
| for each herbicide or herbicidal | (Helianthus) | serriola) | convolvulus) | Rusby) |
| mixture | (1 trial) | (1 trial) | (1 trial) | (1 trial) |
| Formulation Example 2 (60 g/ha | 0 | 0 | 0 | 0 |
| pinoxaden) | | | | |
| Formulation Example 1 (60 g/ha | 55.0 | 100 | 94.7 | 78.3 |
| pinoxaden + 105 g/ha fluroxypyr (AE)) | | | | |
| Formulation Ex. 1 (60 g/ha pinoxaden + | 99.0 | 100 | 98.0 | 91.7 |
| 105 g/ha fluroxypyr (AE)) tank-mixed with | | | | |
| Orion ™ 353 g/ha | | | | |
| Formulation Ex. 1 (60 g/ha pinoxaden + | 53.3 | 100 | 96.7 | 86.7 |
| 105 g/ha fluroxypyr (AE)) tank-mixed with | | | | |
| Weco Max ™ 473 g/ha | | | | |
| Formulation Ex. 1 (60 g/ha pinoxaden + | 97.7 | 100 | 97.7 | 91.7 |
| 105 g/ha fluroxypyr (AE)) tank-mixed with | | | | |
| Affinity TankMix ™ 21 g/ha | | | | |
| Formulation Ex. 1 (60 g/ha pinoxaden + | 97.7 | 100 | 98.0 | 93.3 |
| 105 g/ha fluroxypyr (AE)) tank-mixed with | | | | |
| MCPA 260 g/ha (AE) and Affinity | | | | |
| TankMix ™ 10.5 g/ha | | | | |
| Formulation Ex. 1 (60 g/ha pinoxaden + | 86.7 | 100 | 97.7 | 91.7 |
| 105 g/ha fluroxypyr (AE)) tank-mixed with | | | | |
| Affinity BroadSpec ™ 14 g/ha | | | | |
| Formulation Ex. 1 (60 g/ha pinoxaden + | 97.7 | 100 | 97.3 | 93.3 |
| 105 g/ha fluroxypyr (AE)) tank-mixed with | | | | |
| MCPA 260 g/ha (AE) and Affinity | | | | |
| BroadSpec ™ 7 g/ha | | | | |
| Formulation Ex. 1 (60 g/ha pinoxaden + | 99.0 | 100 | 98.0 | 86.7 |
| 105 g/ha fluroxypyr (AE)) tank-mixed with | | | | |
| Peak ™ 10 g/ha | | | | |
| Formulation Ex. 1 (60 g/ha pinoxaden + | 99.0 | 100 | 98.3 | 90.0 |
| 105 g/ha fluroxypyr (AE)) tank-mixed with | | | | |
| MCPA 260 g/ha (AE) and Peak ™ 10 g/ha | | | | |
| Formulation Ex. 1 (60 g/ha pinoxaden + | 99.0 | 100 | 98.3 | 85.0 |
| 105 g/ha fluroxypyr (AE)) tank-mixed with | | | | |
| Amber ™ 14.7 g/ha | | | | |
| Formulation Ex. 1 (60 g/ha pinoxaden + | 99.0 | 100 | 97.7 | 85.0 |
| 105 g/ha fluroxypyr (AE)) tank-mixed with | | | | |
| MCPA 260 g/ha (AE) and Amber ™ | | | | |
| 14.7 g/ha | | | | |
| Formulation Ex. 1 (60 g/ha pinoxaden + | 56.7 | 78.3 | 96.5 | 86.7 |
| 105 g/ha fluroxypyr (AE)) tank-mixed with | | | | |
| Bronate Advanced ™ 420 g/ha | | | | |
| Formulation Ex. 1 (60 g/ha pinoxaden + | 61.7 | 78.3 | 95.0 | 85.0 |
| 105 g/ha fluroxypyr (AE)) tank-mixed with | | | | |
| Bison ™ 420 g/ha | | | | |
| Formulation Ex. 1 (60 g/ha pinoxaden + | 99.0 | 100 | 95.3 | 91.7 |
| 105 g/ha fluroxypyr (AE)) tank-mixed with | | | | |
| Huskie ™ 199 g/ha + ammonium sulfate | | | | |
| Wolverine ™ 330 g/ha | 99.0 | 100 | 96.3 | 86.7 |
| Goldsky ™ 118 g/ha and non-ionic | 99.0 | 51.7 | 97.0 | 86.7 |
| surfactant (as adjuvant) | | | | |
| Tank-mix of Formulation Example 2 | 46.7 | 100 | 98.3 | 85.0 |
| (60 g/ha pinoxaden) and Starane ™ | | | | |
| (105 g/ha fluroxypyr (AE)) | | | | |
| Tank-mix of Formulation Example 2 | 91.3 | 81.7 | 96.3 | 86.7 |
| (60 g/ha pinoxaden) and Widematch ™ | | | | |
| 210 g/ha | | | | |

Notes to Table 4 from Biological Example 2:
AE = acid equivalent.
Orion ™ herbicide (from Syngenta) comprises MCPA (ca. 42.25%) and florasulam (ca. 0.39%). It is thought the the MCPA was applied at ca. 348 g/ha AE, and the florasulam at ca. 5 g/ha.
Weco Max ™ herbicide (from Bayer) comprises bromoxynil octanoate (14.8%), bromoxynil heptanoate (14.3%), 2,4-D 2-ethylhexyl ester (38.6%) and xylene range/petroleum distillates.
Affinity TankMix ™ herbicide (as soluble granules) (from DuPont) comprises thifensulfuron-methyl (40 wt %) and tribenuron-methyl (10 wt %).
Affinity BroadSpec ™ herbicide (as soluble granules) (from DuPont) comprises thifensulfuron-methyl (25 wt %) and tribenuron-methyl (25 wt %).
Peak ™ herbicide (from Syngenta) contains prosulfuron. It is thought the prosulfuron was applied at ca. 10 g/ha AE.
Amber ™ herbicide (from Syngenta) contains triasulfuron. It is thought the triasulfuron was applied at ca. 14.7 g/ha AE.
Bronate Advanced ™ herbicide (from Bayer) comprises bromoxynil octanoate (18.7%), bromoxynil heptanoate (18.1%), MCPA 2-ethylhexyl ester (40.0%) and petroleum distillates.
Bison ™ herbicide (from Agrisolutions ™, distributed by Winfield Solutions LLC, St Paul, MN, USA) contains 31.7% of the octanoic acid ester of bromoxynil (3,5-dibromo-4-hydroxybenzonitrile) (equivalent to 21.8% of bromoxynil free compound), 34.0% of the 2-ethylhexyl ester of 2-methyl-chlorophenoxyacetic acid (MCPA) (equivalent to 21.8% of MCPA free acid), and 34.3% of inert ingredients including petroleum distillate.
Huskie ™ herbicide (from Bayer) comprises pyrasulfotole (3.3%), bromoxynil octanoate (13.4%), bromoxynil heptanoate (12.9%) and inert ingredients (70.4%) including petroleum distillate. Pyrasulfotole is protected by U.S. Pat. No. 6,420,317. It is thought that, in Biological Example 2, pyrasulfotole was applied at ca. 30 g/ha, and that the bromoxynil was applied at ca. 168.6 g/ha AE.
Wolverine ™ herbicide (from Bayer) comprises fenoxaprop-p-ethyl (4.47%, a grassy-weed-herbicide, thought possibly to be applied at ca. 90.6 g/ha), pyrasulfotole (1.94%, thought possibly to be applied at ca. 30 to ca. 40.5 g/ha), and bromoxynil octanoate (4.95%) and bromoxynil heptanoate (4.79%). In Wolverine ™, the bromoxynil application rate is not fully known, but the bromoxynil is thought probably to be applied at ca. 139 g/ha AE.
Goldsky ™ herbicide (from Dow AgroSciences) comprises florasulam (0.20%), fluroxypyr-meptyl (11.57% as the ester, or 8.03% fluroxypyr AE), and pyroxsulam (1.20%), and petroleum distillates.
Starane ™ herbicide (from Dow AgroSciences) comprises fluroxypyr-meptyl (26.2% as the ester, or 18.2% fluroxypyr AE) and other ingredients (73.8%).
Widematch ™ herbicide (from Dow AgroSciences) comprises fluroxypyr-meptyl (12.3%) and clopyralid MEA salt (11.3%).

### BIOLOGICAL EXAMPLE 3

### Canadian Field Trial Results

Trials were conducted comparing Formulation Example 1 applied at 165 g active ingredient/ha (16.4 fl oz) [60 g/ha pinoxaden+105 g/ha fluoroxypyr AE], versus Starane™ (an EC containing fluoroxypyr-meptyl) applied at 105 g/ha fluoroxypyr AE (8 fl oz), on 16 wheat and 7 barley fields across Canada (in three provinces: Alberta (AB), Manitoba (MB), and Saskatchewan (SK)). Barley trials were planted between May 12th and May 27th, with wheat trials planted between May 12th and June 2nd. Plot sizes were 2 m (6.5 ft) by 6 m (20 ft) with 4 replications of treatments (weed control results are presented as an average of the 4 repetitions). The crop seedling rate ranged from 75 to 105 kg/ha (67-94 lb/A) on 15-23 cm (6-9 inch) row spacing. 7 trials were conducted on reduced/minimum tillage soils and the remaining 16 trials were conducted on conventional tillage soils. Soil pH ranged from 6.7 to 8.3 across trials with soil organic matter ranging from 2.3 to 7%.

Each of the tested herbicidal compositions (e.g. Formulation Example 1, or Starane™, both EC's) was mixed with water before use, to form a diluted aqueous herbicidal composition suitable for spraying. Spray applications, of the diluted herbicidal composition under test, were made post-emergence to 4-6 leaf (1-3 tiller) barley and 3-5 leaf (0-2 tiller) wheat between June 23rd to July 1st and June 2-29, respectively, at 100 L/ha and 35 PSI. Barley height ranged from 0.15 to 0.28 m (6-11 in) while wheat height ranged from 0.10 to 0.28 m (4-11 in). Weed heights, leaf numbers, and density range at the time of application were as follows (noting that any given trial location may only have one, two or three of these weed species present):

| Weed | Height | Leaf Number (Tiller (T)) | Density (plants/m²) |
|---|---|---|---|
| 1. “kochia” (Kochia | 1-10 cm (0.4-4 in) | 2-14 leaves | 50-500 |
| scoparia) | | | |
| 2. wild buckwheat | 1-10 cm (0.4-4 in) | 1-5 leaves | 12-150 |
| (Polygonum | | | |
| convolvulus = Fallopia | | | |
| convolvulus) | | | |
| 3. wild oat (Avena | 8-14 cm (3-5.5 in) | 2-4 leaves (0-1 T) | 120-2000 |
| fatua) | | | |
| 4. green foxtail | 3-10 cm (1-3 in) | 2-6 leaves (0-2 T) | 10-550 |
| (Setaria viridis) | | | |

Results of individual Canadian field trials are given below, after a summary of the overall results.

In some of the Canadian individual field trials (e.g. CA field trial numbers 11, 12 and 13), results are also presented below for the post-emergent herbicidal efficacy, e.g. vs. various broadleaf weeds, of tank-mixes of Formulation Example 1 mixed with either (a) Mextrol 450 ™ liquid herbicide, or (b) Infinity™ herbicide, or (c) Frontline XL™ herbicide.
Mextrol 450™ liquid herbicide, available in Canada from Nufarm, is a 450 EC and contains bromoxynil (present as the octanoate ester) (225 g/L) and MCPA (present as the 2-ethylhexyl ester) (225 g/L), and is usually applied at 1.25 L/ha. In the Canadian field trials, Mextrol 450™ was applied at a rate of 450 g total active ingredient (as AE)/ha.
Infinity™ herbicide, available in Canada from Bayer CropScience, is a 247.5 EC and contains pyrasulfotole (37.5 g/L) and bromoxynil (present as mixed octanoate and heptanoate esters) (210 g/L), and is usually applied at a rate of 0.83 L/ha (which corresponds to 31 g/ha pyrasulfotole and 174 g/ha bromoxynil either as AE or more likely as the bromoxynil esters). In the Canadian field trials, Infinity™ was applied at a rate of 103 g total active ingredient (as AE)/ha.
Frontline XL™ herbicide, available in Canada from Dow AgroSciences, is a 284 SE and contains florasulam (4 g/L), MCPA 2-ethylhexyl ester (280 g AE/L), as well as 0.02% of 1,2-benzisothiazoline-3-one as preservative; and is usually applied at 1.25 L/ha. In the Canadian field trials, Frontline XL™ was applied at a rate of 355 g total active ingredient/ha (that is: 5 g florasulam AE/ha, and 350 g MCPA AE/ha).
AE=acid equivalent.

### Summary of Results for Biological Example 3

Formulation Example 1 did provide a numerical increase, compared to Starane™, in percentage control of Kochia scoparia (“kochia”), for 3 out of 7 the field trial locations, at 28 to 33 DAA (DAA=days after application of herbicide); see detailed results of Canadian field trials 1, 2 and 5 below. One of these trials showing a numerical increase in kochia control with Formulation Example 1 (Canadian field trial 1, 60% control, cf. 55% with Starane™) had, at the time of herbicide application, Kochia scoparia weeds present at a high density (ca. 300-500 plants/m²) and having a height of 3-8 cm (ca. 10-14 leaves). 1 of the 7 trials (Canadian field trial 3) showed a noticeable numerical decrease in percentage control of Kochia scoparia, for Formulation Example 1 compared to Starane™.

Statistically, Formulation Example 1 and Starane™ provided equivalent control of kochia (Kochia scoparia) and wild buckwheat (Polygonum convolvulus) at 21 to 45 DAA.

Formulation Example 1 provided excellent control of wild oat (Avena fatua) and green foxtail (Setaria viridis) (>90% control of one of these 2 grassy weeds at 10 out of 11 locations; generally at ca. 21 to 45 DAA; detailed results not shown).

The addition of pinoxaden and TEHP to fluoroxypyr-meptyl, as found in Formulation Example 1, appears probably to provide a slight benefit to kochia control, compared to Starane™, while also providing excellent grassyweed control which is not seen with Starane™.

Data from Individual Canadian Field Trials, in Biological Example 3

Data from individual Canadian field trials which relate to control of broadleaf weeds is now presented.

Canadian Field Trial 1—Kochia scoparia

Assessment was of control of Kochia scoparia in summer barley, at a trial site in Alberta, Canada:
Formulation Example 1 achieved an average of 60% control of Kochia scoparia at 30 DAA (with individual values of 70, 50, 70, 50% control).
Starane™ (fluoroxypyr EC) achieved an average of 55% control of Kochia scoparia at 30 DAA (with individual values of 70, 40, 60, 50% control).

Conditions for Canadian Field Trial 1:

Soil: loam, drainage poor. Harrington/Copeland summer barley was seeded at 100 kg/ha and at 4-6 cm depth using a double-disc press drill on 12th May, and mono-ammonium phosphate was placed with the seed; urea was also added to the area on 12th May by broadcasting and rototilling. The main characteristic of the growing season (May 1st to August 19th) in this trial was the presence of wetter and cooler than normal conditions in May, and cooler than normal temperatures for May, June, July and August. During the period May 20th to May 30th, average temperatures ranged from 1.2 to 9.6° C., a significant drop from the average temperatures of 3.7 to 17.9° C. for the previous ten day period of May 10th to 20th. The cool period occurred at a time when the majority of the crops in the area had been seeded and germination was occurring. The cold temperatures at this critical period greatly delayed crop emergence and slowed development of emerged crops. On the day of the herbicide application (June 28th), the Kochia scoparia was of height 3-8 cm (ca. 10-14 leaves) and was present at a high density of ca. 300-500 plants/m² (compared to, on this day: ca. 150-180 barley crop plants/m², and barley crop having: height 20-30 cm, 4-5 leaves, 1-2 tillers).

Canadian Field Trial 2—Kochia scoparia

Assessment was of control of Kochia scoparia in summer wheat, at a trial site in Alberta, Canada:
Formulation Example 1 achieved an average of 84% control of Kochia scoparia at 33 DAA (with individual values in the range 75-90%).
Starane™ (fluoroxypyr EC) achieved an average of 81% control of Kochia scoparia at 33 DAA (with individual values in the range 75-85%).

Conditions for Canadian Field Trial 2:

Soil: loam, drainage excellent. Extreme levels of precipitation for much of the area led to localized flooding resulting in seeding being delayed by approximately 2 weeks, to 14th May. April precipitation (84.4 mm) was 271% the 29 year average with a number of significant snow events, while May precipitation (99.6 mm) was 185% the 29 year average with a small number of snow events. Precipitation normalized for the remainder of the growing season and crops and weeds rapidly developed through this period, under the excellent growing conditions. On the day of the herbicide application (June 20th), the crop within the trial site was as vigorous and as healthy as the surrounding commercial field; and the Kochia scoparia was of height 1-3 cm (diameter 1-3 cm). Plant densities were: ca. 150-180 crop plants/m² and ca. 50-80 Kochia scoparia plants/m² respectively, on the day of herbicide application.

Canadian Field Trial 3—Kochia scoparia

Assessment was of control of Kochia scoparia in summer barley, at a trial site in Alberta, Canada:
Formulation Example 1 achieved an average of 75% control of Kochia scoparia at 29 DAA (with individual values of 80, 80, 60, 80% control).
Starane™ (fluoroxypyr EC) achieved an average of 85% control of Kochia scoparia at 29 DAA (with individual values of 82, 82, 90, 85% control).

Conditions for Canadian Field Trial 3:

Soil: loam, drainage excellent. Extreme levels of precipitation for much of the area led to localized flooding resulting in seeding being delayed by approximately 2 weeks, to 18th May. April precipitation (84.4 mm) was 271% the 29 year average with a number of significant snow events, while May precipitation (99.6 mm) was 185% the 29 year average with a small number of snow events. Precipitation normalized for the remainder of the growing season and crops and weeds rapidly developed through this period, under the excellent growing conditions. On the day of the herbicide application (June 24th), the crop within the trial site was as vigorous and as healthy as the surrounding commercial field; and the Kochia scoparia was of height 2-6 cm (diameter 3-4 cm). Plant densities were: ca. 175-250 crop plants/m² and ca. 75-100 Kochia scoparia plants/m² respectively, on the day of herbicide application.

Canadian Field Trial 4—Kochia scoparia

Assessment was of control of Kochia scoparia in summer barley, at a trial site in Alberta, Canada:
Formulation Example 1 achieved an average of ca. 84.5% control of Kochia scoparia at 28 DAA (with individual values in the range 80-85%).
Starane™ (fluoroxypyr EC) achieved an average of ca. 84.5% control of Kochia scoparia at 28 DAA (with individual values in the range 80-90%).

Conditions for Canadian Field Trial 4:

Soil: loam, drainage good. Barley (var. Ponoka) was seeded by hoe drill at 100 kg/ha on 18th May. The main characteristic of the growing season (May 1st to August 31st) in this trial was the presence of wetter than normal conditions in May and June, and cooler than normal temperatures for May, June, July and August. On the day of the herbicide application (June 25th), the Kochia scoparia was of height 5-10 cm and was present at a density of ca. 100 plants/m² (compared to ca. 150-170 crop plants/m²).

Canadian Field Trial 5—Kochia scoparia

Assessment was of control of Kochia scoparia in summer.spring wheat, at a trial site in Alberta, Canada:
Formulation Example 1 achieved an average of 88% control of Kochia scoparia at 28 DAA (with individual values in the range 85-90%).
Starane™ (fluoroxypyr EC) achieved an average of 84% control of Kochia scoparia at 28 DAA (with individual values in the range 80-85%).

Conditions for Canadian Field Trial 5:

Soil: loam, drainage good. Spring/summer wheat (var. Superb) was seeded by hoe drill at 100 kg/ha on 18th May. The main characteristic of the growing season (May 1st to August 31st) in this trial was the presence of wetter than normal conditions in May and June, and cooler than normal temperatures for May, June, July and August. On the day of the herbicide application (June 25th), the Kochia scoparia was of height 5-10 cm and was present at a density of ca. 100 plants/m² (compared to ca. 156-170 crop plants/m²).

Canadian Field Trial 6—Kochia scoparia

Assessment was of control of Kochia scoparia in summer/spring wheat, at a trial site in Manitoba, Canada:
Formulation Example 1 achieved an average of 95.75% control of Kochia scoparia at 30 DAA (with individual values of 95, 95, 98, 95% control).
Starane™ (fluoroxypyr EC) achieved an average of 96.5% control of Kochia scoparia at 30 DAA (with individual values of 98, 98, 95, 95% control).

Conditions for Canadian Field Trial 6:

Soil: clay loam, drainage good. Summer/spring wheat (cv. AC Barrie) was seeded on 7th May at 80 kg/ha. The weed species present at the site was Kochia scoparia. On the day of the herbicide application by spraying (June 9th), the Kochia scoparia was of height 2-10 cm and was present at a density of ca. 60-120 plants/m² (compared to ca. 200-250 crop plants/m²), and the crop was at the 4-5 leaf/2-3 tiller stage (crop height 24-32 cm).

Canadian Field Trial 7—Kochia scoparia

Assessment was of control of Kochia scoparia in summer/spring wheat, at a trial site in Manitoba, Canada:
Formulation Example 1 achieved an average of 95% control of Kochia scoparia at 30 DAA (with all individual values being 95% control).
Starane™ (fluoroxypyr EC) achieved an average of 95% control of Kochia scoparia at 30 DAA (with all individual values being 95% control).

Conditions for Canadian Field Trial 7:

Soil: clay loam, drainage good. Summer/spring wheat (cv. AC Barrie) was seeded on 12th May at 80 kg/ha. The weed species present at the site was Kochia scoparia. On the day of the herbicide application by spraying (June 16th), the Kochia scoparia was of height 2-8 cm and was present at a density of ca. 70-120 plants/m² (compared to ca. 200-250 crop plants/m²), and the crop was at the 4-5 leaf/1-3 tiller stage (crop height 18-26 cm).

Canadian Field Trial 8—Polygonum convolvulus

Assessment was of control of Polygonum convolvulus in summer barley, at a trial site in Alberta, Canada:
Formulation Example 1 achieved an average of 95% control of Polygonum convolvulus at 28 DAA (with individual values of 98, 90, 98, 95%).
Starane™ (fluoroxypyr EC) achieved an average of 98% control of Polygonum convolvulus at 28 DAA (with individual values all being 98%).

Conditions for Canadian Field Trial 8:

Soil: loamy sand, drainage excellent. Summer barley (AC Metcalfe) was seeded at 80 kg/ha and at 4-6 cm depth using a double-disc press drill on 19th May, and mono-ammonium phosphate was placed with the seed; urea was also added to the area beforehand on 17 May by broadcasting and rototilling. The main characteristic of the growing season (May 1st to August 19th) in this trial was the presence of wetter than normal conditions in May, and cooler than normal temperatures for May, June, July and August. In particular, there was a period of cooler than normal temperatures from May 20th to May 30^{th} which delayed crop emergence and resulted in a delay in crop development of between 7 to 14 days. On the day of the herbicide application (June 23rd), the Polygonum convolvulus was of height 1-5 cm (ca. 1-4 leaves) and was present at a density of ca. 50-150 plants/m² (compared to, on this day: ca. 150-180 barley crop plants/m², and barley crop having: height 15-25 cm, 4-5 leaves, 1-3 tillers).

Canadian Field Trial 9—Polygonum convolvulus

Assessment was of control of Polygonum convolvulus in summer wheat, at a trial site in Manitoba, Canada:
Formulation Example 1 achieved an average of 95% control of Polygonum convolvulus at 28 DAA (with all individual values being 95% control).
Starane™ (fluoroxypyr EC) achieved an average of 95% control of Polygonum convolvulus at 28 DAA (with all individual values being 95% control).

Conditions for Canadian Field Trial 9:

Soil: clay loam, drainage good. Summer wheat (variety 859) was seeded on 14th May at 100 kg/ha. On the day of the herbicide application by spraying (June 2nd), the Polygonum convolvulus was of height 4-6 cm (ca. 2-3 leaves) and was present at a density of ca. 100-150 plants/m² (compared to, on this day: ca. 200-250 crop plants/m², crop height 10-15 cm, and crop at the 3-4 leaf and 1 tiller stage).

Canadian Field Trial 10—Polygonum convolvulus

Assessment was of control of Polygonum convolvulus in summer wheat, at a trial site in Manitoba, Canada:
Formulation Example 1 achieved an average of 95% control of Polygonum convolvulus at 28 DAA (with all individual values being 95% control).
Starane™ (fluoroxypyr EC) achieved an average of 95% control of Polygonum convolvulus at 28 DAA (with all individual values being 95% control).

Conditions for Canadian Field Trial 10:

Soil: clay loam, drainage good. Summer wheat (variety 859) was seeded on 20th May at 100 kg/ha. On the day of the herbicide application by spraying (June 3rd), the Polygonum convolvulus was of height 4-6 cm (ca. 2-3 leaves) and was present at a density of ca. 50-75 plants/m² (compared to, on this day: ca. 200-250 crop plants/m², crop height 12-15 cm, and crop at the 3-4 leaf and 0-1 tiller stage).

Canadian Field Trial 11—Setaria viridis, Polygonum convolvulus, and Sinapsis arvensis

Assessment was of control of Setaria viridis (“green foxtail”), Polygonum convolvulus (“wild buckwheat”), and Sinapsis arvensis (“wild mustard”) in spring/summer wheat, at a trial site in Saskatchewan, Canada:
Formulation Example 1 achieved an average of 96% (95-99%) control and an average of 96% (95-99%) control of Setaria viridis, at 30 and 50 DAA respectively.
Starane™ (fluoroxypyr EC) achieved an average of 0% (all values 0%) control and an average of 0% (all values 0%) control of Setaria viridis, at 30 and 50 DAA respectively.
A tank-mix of Formulation Example 1 and Mextrol 450™ (Nufarm, bromoxynil octanoate, and MCPA 2-ethylhexyl ester) achieved an average of 95% (90-99%) control and an average of 97% (95-99%) control of Setaria viridis, at 30 and 50 DAA respectively.
A tank-mix of Formulation Example 1 and Infinity™ (Bayer, pyrasulfotole, and bromoxynil octanoate+heptanoate) achieved an average of 97% (95-99%) control and an average of 98% (95-99%) control of Setaria viridis, at 30 and 50 DAA respectively.
A tank-mix of Formulation Example 1 and Frontline XL™ (Dow, florasulam, and MCPA 2-ethylhexyl ester) achieved an average of 97% (95-99%) control and an average of 97% (95-99%) control of Setaria viridis, at 30 and 50 DAA respectively.
Formulation Example 1 achieved an average of 84% (75-99%) control and an average of 82% (75-99%) control of Polygonum convolvulus, at 30 and 50 DAA respectively.
Starane™ (fluoroxypyr EC) achieved an average of 86% (80-95%) control and an average of 85% (75-95%) control of Polygonum convolvulus, at 30 and 50 DAA respectively.
A tank-mix of Formulation Example 1 and Mextrol 450™ (Nufarm, bromoxynil octanoate, and MCPA 2-ethylhexyl ester) achieved an average of 96% (90-99%) control and an average of 98% (95-99%) control of Polygonum convolvulus, at 30 and 50 DAA respectively.
A tank-mix of Formulation Example 1 and Infinity™ (Bayer, pyrasulfotole, and bromoxynil octanoate+heptanoate) achieved an average of 98% (95-99%) control and an average of 98% (95-99%) control of Polygonum convolvulus, at 30 and 50 DAA respectively.
A tank-mix of Formulation Example 1 and Frontline XL™ (Dow, florasulam, and MCPA 2-ethylhexyl ester) achieved an average of 97% (95-99%) control and an average of 98% (95-99%) control of Polygonum convolvulus, at 30 and 50 DAA respectively.
Formulation Example 1 achieved an average of 60% (50-90%) control and an average of 61% (50-95%) control of Sinapsis arvensis, at 30 and 50 DAA respectively.
Starane™ (fluoroxypyr EC) achieved an average of 50% (all values 50%) control and an average of 50% (all values 50%) control of Sinapsis arvensis, at 30 and 50 DAA respectively.
A tank-mix of Formulation Example 1 and Mextrol 450™ (Nufarm, bromoxynil octanoate, and MCPA 2-ethylhexyl ester) achieved an average of 99% control (all values 99%) and an average of 99% control (all values 99%) of Sinapsis arvensis, at 30 and 50 DAA respectively.
A tank-mix of Formulation Example 1 and Infinity™ (Bayer, pyrasulfotole, and bromoxynil octanoate+heptanoate) achieved an average of 99% control (all values 99%) and an average of 99% control (all values 99%) of Sinapsis arvensis, at 30 and 50 DAA respectively.
A tank-mix of Formulation Example 1 and Frontline XL™ (Dow, florasulam, and MCPA 2-ethylhexyl ester) achieved an average of 99% control (all values 99%) and an average of 99% control (all values 99%) of Sinapsis arvensis, at 30 and 50 DAA respectively.

Conditions for Canadian Field Trial 11:

Soil: clay loam, drainage good. Spring/summer wheat (variety Infinity) was seeded at 80 kg/ha using a double-disc press drill on 27th May. The weeds assessed in this trial were Setaria viridis (“green foxtail”), Polygonum convolvulus (“wild buckwheat”), and Sinapsis arvensis (“wild mustard”). On the day of the herbicide application (June 28th), the densities of the plants present were:
Setaria viridis: density ca. 90-112 plants/m² (development stage BBCH 13-14);
Polygonum convolvulus: density ca. 12-18 plants/m² (development stage BBCH 12-13);
Sinapsis arvensis: density ca. 16-24 plants/m² (development stage BBCH 12-14); and
spring/summer wheat (variety Infinity): density ca. 175-200 plants/m² (development stage BBCH 15-22).
   Canadian Field Trial 12—Polygonum convolvulus, Amaranthus retroflexus, and Chenopodium album

Assessment was of control of Polygonum convolvulus (“wild buckwheat”), Amaranthus retroflexus (“redroot pigweed”), and Chenopodium album (“common lambsquarters”) in summer barley, at a trial site in Saskatchewan, Canada:
Formulation Example 1 achieved an average of 86% control of Polygonum convolvulus at 34 DAA (with individual values in the range 80-90%).
Starane™ (fluoroxypyr EC) achieved an average of 86% control of Polygonum convolvulus at 34 DAA (with individual values in the range 85-90%).
A tank-mix of Formulation Example 1 and Mextrol 450™ (Nufarm, bromoxynil octanoate, and MCPA 2-ethylhexyl ester) achieved an average of 97% control of Polygonum convolvulus at 34 DAA (with individual values in the range 95-99%).
A tank-mix of Formulation Example 1 and Infinity™ (Bayer, pyrasulfotole, and bromoxynil octanoate+heptanoate) achieved an average of 97% control of Polygonum convolvulus at 34 DAA (with individual values in the range 95-99%).
A tank-mix of Formulation Example 1 and Frontline XL™ (Dow, florasulam, and MCPA 2-ethylhexyl ester) achieved an average of 98% control of Polygonum convolvulus at 34 DAA (with individual values in the range 95-99%).
Formulation Example 1 achieved an average of 15% control of Amaranthus retroflexus at 34 DAA (with individual values of 0, 20, 20, 20%).
Starane™ (fluoroxypyr EC) achieved an average of 20% control of Amaranthus retroflexus at 34 DAA (with individual values all being 20%).
A tank-mix of Formulation Example 1 and Mextrol 450™ (Nufarm, bromoxynil octanoate, and MCPA 2-ethylhexyl ester) achieved an average of 91% control of Amaranthus retroflexus at 34 DAA (with individual values in the range 85-95%).
A tank-mix of Formulation Example 1 and Infinity™ (Bayer, pyrasulfotole, and bromoxynil octanoate+heptanoate) achieved an average of 98% control of Amaranthus retroflexus at 34 DAA (with individual values in the range 95-99%).
A tank-mix of Formulation Example 1 and Frontline XL™ (Dow, florasulam, and MCPA 2-ethylhexyl ester) achieved an average of 99% control of Amaranthus retroflexus at 34 DAA (with individual values all being 99%).
Formulation Example 1 achieved an average of 0% control of Chenopodium album at 35 DAA (with all individual values being 0%).
Starane™ (fluoroxypyr EC) achieved an average of 0% control of Chenopodium album at 35 DAA (with all individual values being 0%).
A tank-mix of Formulation Example 1 and Mextrol 450™ (Nufarm, bromoxynil octanoate, and MCPA 2-ethylhexyl ester) achieved an average of 99% control of Chenopodium album at 35 DAA (with individual values all being 99%).
A tank-mix of Formulation Example 1 and Infinity™ (Bayer, pyrasulfotole, and bromoxynil octanoate+heptanoate) achieved an average of 99% control of Chenopodium album at 35 DAA (with individual values all being 99%).
A tank-mix of Formulation Example 1 and Frontline XL™ (Dow, florasulam, and MCPA 2-ethylhexyl ester) achieved an average of 99% control of Chenopodium album at 35 DAA (with individual values all being 99%).

Conditions for Canadian Field Trial 12:

Soil: clay loam, drainage good. Summer barley (variety Metcalfe) was seeded at 75 kg/ha using a double-disc press drill on 27th May. The weeds assessed in this trial were Polygonum convolvulus (“wild buckwheat”), Amaranthus retroflexus (“redroot pigweed”), and Chenopodium album (“common lambsquarters”). On the day of the herbicide application (June 23rd), the densities of the plants present were:
Polygonum convolvulus: density ca. 12-16 plants/m² (development stage BBCH 11-13);
Amaranthus retroflexus: density ca. 6-10 plants/m² (development stage BBCH 13-15);
Chenopodium album: density ca. 4-10 plants/m² (development stage BBCH 14-18);
summer barley (variety Metcalfe): density ca. 175-200 plants/m² (development stage BBCH 14-21; 4-5 leaf, 1 tiller stage).
   Canadian Field Trial 13—Polygonum convolvulus, and Brassica napus

Assessment was of control of Polygonum convolvulus (“wild buckwheat”) and Brassica napus (“volunteer canola (rapeseed)”) in summer wheat, at a trial site in Saskatchewan, Canada:
Formulation Example 1 achieved an average of 81% control of Polygonum convolvulus at 34 DAA (with individual values in the range 75-85%).
Starane™ (fluoroxypyr EC) achieved an average of 75% control of Polygonum convolvulus at 34 DAA (with individual values in the range 70-80%).
A tank-mix of Formulation Example 1 and Mextrol 450™ (Nufarm, bromoxynil octanoate, and MCPA 2-ethylhexyl ester) achieved an average of 97% control of Polygonum convolvulus at 34 DAA (with individual values in the range 95-99%).
A tank-mix of Formulation Example 1 and Infinity™ (Bayer, pyrasulfotole, and bromoxynil octanoate+heptanoate) achieved an average of 99% control of Polygonum convolvulus at 34 DAA (with individual values all being 99%).
A tank-mix of Formulation Example 1 and Frontline XL™ (Dow, florasulam, and MCPA 2-ethylhexyl ester) achieved an average of 98% control of Polygonum convolvulus at 34 DAA (with individual values in the range 95-99%).
Formulation Example 1 achieved an average of 38% control of Brassica napus at 34 DAA (with individual values in the range of 25-50%).
Starane™ (fluoroxypyr EC) achieved an average of 31% control of Brassica napus at 34 DAA (with individual values in the range of 25-50%).
A tank-mix of Formulation Example 1 and Mextrol 450™ (Nufarm, bromoxynil octanoate, and MCPA 2-ethylhexyl ester) achieved an average of 99% control of Brassica napus at 34 DAA (with individual values all being 95-99%).
A tank-mix of Formulation Example 1 and Infinity™ (Bayer, pyrasulfotole, and bromoxynil octanoate+heptanoate) achieved an average of 99% control of Brassica napus at 34 DAA (with individual values all being 99%).
A tank-mix of Formulation Example 1 and Frontline XL™ (Dow, florasulam, and MCPA 2-ethylhexyl ester) achieved an average of 99% control of Brassica napus at 34 DAA (with individual values all being 95-99%).

Conditions for Canadian Field Trial 13:

Soil: clay loam, drainage good. Summer wheat (variety Superb) was seeded at 80 kg/ha using a double-disc press drill on 27th May. The weeds assessed in this trial were Polygonum convolvulus (“wild buckwheat”) and Brassica napus (“volunteer canola (rapeseed)”). On the day of the herbicide application (June 23rd), the characteristics of the plants present were:
Polygonum convolvulus: density ca. 12-16 plants/m² (development stage BBCH 11-13);
Brassica napus: density ca. 8-14 plants/m² (development stage BBCH 13-14);
summer wheat (variety Superb): development stage BBCH 13-21 (3-5 leaf, 1 tiller stage).

1. A liquid herbicidal composition in the form of an emulsifiable concentrate, comprising a mixture of:
(i) pinoxaden;
(ii) a C₁-C₁₂alkyl ester or a 2-(C₁-C₆alkoxy)C₂-C₄alkyl-ester of fluoroxypyr; and
(iii) a built-in phosphate and/or phosphonate adjuvant;
wherein the built-in phosphate and/or phosphonate adjuvant comprises a tris-[C₄-C₁₂alkyl or 2-(C₂-C₆alkoxy)C₂-C₄alkyl-]ester of phosphoric acid and/or a bis-(C₃-C₁₂alkyl) ester of a C₃-C₁₂alkyl-phosphonic acid.

2. A composition as claimed in claim 1, wherein the liquid herbicidal composition in the form of the emulsifiable concentrate contains less than 1% w/w of water by weight of the liquid herbicidal composition.

3. A composition as claimed in claim 1, wherein the ester of fluoroxypyr is the 1-methylheptyl ester of fluoroxypyr or is the 2-butoxy-1-methylethyl ester of fluoroxypyr.

4. A composition as claimed in claim 1, wherein the liquid herbicidal composition comprises from 1% to 20% pinoxaden, by weight of the liquid herbicidal composition.

5. A composition as claimed in claim 4, wherein the liquid herbicidal composition comprises from 2% to 30% of the ester of fluoroxypyr (measured as the ester), by weight of the liquid herbicidal composition.

6. A composition as claimed in claim 1, wherein the weight ratio of the pinoxaden to the ester of fluoroxypyr (calculated as the equivalent amount of fluoroxypyr free carboxylic acid, i.e. calculated as the fluoroxypyr “acid equivalent” (AE)) is from 60:70 to 60:250.

7. A composition as claimed in claim 6, wherein the weight ratio of the pinoxaden to the ester of fluoroxypyr (calculated as the equivalent amount of fluoroxypyr free carboxylic acid, i.e. calculated as the fluoroxypyr “acid equivalent” (AE)) is from 60:70 to 60:160.

8. A composition as claimed in claim 6, wherein the weight ratio of the pinoxaden to the ester of fluoroxypyr (calculated as the equivalent amount of fluoroxypyr free carboxylic acid, i.e. calculated as the fluoroxypyr “acid equivalent” (AE)) is from 60:90 to 60:120.

9. A composition as claimed in claim 6, wherein the weight ratio of the pinoxaden to the ester of fluoroxypyr (calculated as the equivalent amount of fluoroxypyr free carboxylic acid, i.e. calculated as the fluoroxypyr “acid equivalent” (AE)) is from 60:100 to 60:110.

10. A composition as claimed in claim 1, wherein the built-in phosphate and/or phosphonate adjuvant comprises tris-(2-ethylhexyl) phosphate, tris-n-octyl phosphate, tris-[2-(n-butoxy)ethyl]phosphate, bis-(2-ethylhexyl) (2-ethylhexyl)phosphonate, bis-(2-ethylhexyl) (n-octyl)phosphonate and/or di-n-butyl (n-butyl)phosphonate.

11. A composition as claimed in claim 10, wherein the built-in phosphate and/or phosphonate adjuvant comprises tris-(2-ethylhexyl) phosphate.

12. A composition as claimed in claim 1, wherein the built-in phosphate and/or phosphonate adjuvant is present in from 10% to 60% by weight of the liquid herbicidal composition.

13. A composition as claimed in claim 10, wherein the built-in phosphate and/or phosphonate adjuvant is present in from 20% to 45% by weight of the liquid herbicidal composition.

14. A composition as claimed in claim 1, comprising:
a heavy aromatic hydrocarbon solvent; and
an alcohol solvent comprising tetrahydrofurfuryl alcohol, 2-methyl-pentane-2,4-diol, 4-hydroxy-4-methyl-pentane-2-one, benzyl alcohol, 2-ethylhexanol, n-octanol, cyclohexanol, lactic acid methyl ester, lactic acid butyl ester, benzyl lactate, or a mixture of two or more of these alcohols.

15. A composition as claimed in claim 14, wherein the alcohol solvent comprises tetrahydrofurfuryl alcohol, 2-methyl-pentane-2,4-diol, 4-hydroxy-4-methyl-pentane-2-one, or a mixture of two or more of these alcohols.

16. A composition as claimed in claim 14, wherein:
the heavy aromatic hydrocarbon solvent is present in from 10% to 45% by weight of the liquid herbicidal composition;
the alcohol solvent is present in from 8% to 40% by weight of the liquid herbicidal composition; and
the weight ratio of the heavy aromatic hydrocarbon solvent to the alcohol solvent is from 3:1 to 0.5:1.

17. A composition as claimed in claim 16, wherein:
the heavy aromatic hydrocarbon solvent is present in from 10% to 45% by weight of the liquid herbicidal composition;
the alcohol solvent is present in from 15% to 40% by weight of the liquid herbicidal composition; and
the weight ratio of the heavy aromatic hydrocarbon solvent to the alcohol solvent is from 1.5:1 to 0.5:1.

18. A composition as claimed in claim 1, which comprises, by weight of the liquid herbicidal composition:
(i) from 1% to 20% pinoxaden;
(ii) from 2% to 30% of the ester of fluoroxypyr (measured as the ester);
(iii) from 10% to 60% of the built-in phosphate and/or phosphonate adjuvant;
(iv) from 1% to 20% of one or more emulsifiers;
(v) from 8% to 40% of an alcohol solvent comprising tetrahydrofurfuryl alcohol, 2-methyl-pentane-2,4-diol, 4-hydroxy-4-methyl-pentane-2-one, benzyl alcohol, 2-ethylhexanol, n-octanol, cyclohexanol, lactic acid methyl ester, lactic acid butyl ester, benzyl lactate, or a mixture of two or more of these alcohols; and
(vi) from 10% to 45% of heavy aromatic hydrocarbon solvent;
and wherein the weight ratio of the pinoxaden to the ester of fluoroxypyr (calculated as the equivalent amount of fluoroxypyr free carboxylic acid, i.e. calculated as the fluoroxypyr “acid equivalent” (AE)) is: from 60:70 to 60:160.

19. A composition as claimed in claim 18, wherein:
the alcohol solvent is present in from 15% to 40% by weight of the liquid herbicidal composition; and
the weight ratio of the heavy aromatic hydrocarbon solvent to the alcohol solvent is from 1.5:1 to 0.5:1.

20. A composition as claimed in claim 14,
wherein the alcohol solvent comprises tetrahydrofurfuryl alcohol which is present in 50% or more by weight of the alcohol solvent; and
wherein the alcohol solvent and/or the liquid herbicidal composition comprises a boron-based stabilizer.

21. A composition as claimed in claim 20,
wherein the alcohol solvent comprises 96% or more of tetrahydrofurfuryl alcohol by weight of the alcohol solvent; and
wherein the boron-based stabilizer comprises:
(a) a metal borohydride in which the metal is an alkali metal or an alkaline earth metal; and/or
(b1) a metal borate in which the metal is an alkali metal or an alkaline earth metal; and/or
(b2) a compound of formula M⁺ B(H)ₙ(OR)ₘ⁻ wherein M is an alkali metal or an alkaline earth metal, n is 0, 1, 2, or 3, m is 1, 2, 3 or 4 and n+m is 4, and wherein each OR group, independently of any other OR group, is C₁-C₈alkoxy, C₃-C₆cycloalkoxy, (tetrahydrofuran-2-yl)methoxy, benzyloxy, or phenoxy.

22. A composition as claimed in claim 21, wherein the boron-based stabilizer is present in the alcohol solvent in from 0.001% to 0.1% by weight of the alcohol solvent, and/or the boron-based stabilizer is present in the liquid herbicidal composition in from 0.0002% to 0.02% by weight of the liquid herbicidal composition.

23. A composition as claimed in claim 21,
wherein the alcohol solvent comprises 96% or more of tetrahydrofurfuryl alcohol, by weight of the alcohol solvent; and
wherein the alcohol solvent comprising tetrahydrofurfuryl alcohol contains substantially none, that is from 0 to 0.3% by weight of the alcohol solvent, of any solvent which has a C═O moiety;
wherein the boron-based stabilizer comprises:
(a) a sodium, lithium, potassium, magnesium or calcium borohydride; and/or
(b1) a sodium, lithium, potassium, magnesium or calcium borate; and/or
(b2) a compound of formula M⁺ B(H)ₙ(OR)ₘ⁻ wherein M is sodium, lithium, potassium, magnesium or calcium, n is 0, 1, 2, or 3, m is 1, 2, 3 or 4 and n+m is 4, and OR is (tetrahydrofuran-2-yl)methoxy;
and wherein the boron-based stabilizer is present in the alcohol solvent in from 0.002% to 0.05% by weight of the alcohol solvent, and/or the boron-based stabilizer is present in the liquid herbicidal composition in from 0.0004% to 0.01% by weight of the liquid herbicidal composition.

24. A composition as claimed in claim 1,
wherein:
the composition contains substantially no (meaning less than 0.1% w/w of) acidic ingredient(s) which has/have a pKa of 3.5 or less when measured in water at 20 to 26° C.;
the composition contains substantially no (meaning less than 0.001% w/w of) strongly basic ingredient(s) whose conjugate acid(s) has/have a pKa of 10 or more when measured in water at 20 to 26° C.; and
the liquid herbicidal composition contains substantially no water (meaning less than 0.5% w/w of water).

25. (canceled)

26. (canceled)

27. (canceled)

28. (canceled)

29. (canceled)

30. (canceled)

31. (canceled)

32. (canceled)

33. (canceled)

34. A method for controlling and/or inhibiting the growth of dicotyledonous and/or broadleaf weeds, the method comprising the following steps (a) and (b):
(a) mixing, in a container:
(i) a first herbicidal composition,
(ii) an agriculturally-acceptable aqueous solvent which is a carrier suitable for spraying the first herbicidal composition onto a field, and
(iii) optionally, one, two or more further herbicidal compositions,
to form a diluted aqueous liquid herbicidal composition; and
(b) applying the diluted aqueous liquid herbicidal composition to the dicotyledonous and/or broadleaf weeds, or to the locus thereof, at a time after emergence of the weeds;
and wherein the first herbicidal composition is liquid and comprises a mixture of:
(ia) pinoxaden;
(ib) a C₁-C₁₂alkyl ester or a 2-(C₁-C₆alkoxy)C₂-C₄alkyl-ester of fluoroxypyr; and
(ic) a built-in phosphate and/or phosphonate adjuvant; wherein the built-in phosphate and/or phosphonate adjuvant comprises a tris-[C₄-C₁₂alkyl or 2-(C₂-C₆alkoxy)C₂-C₄alkyl-]ester of phosphoric acid and/or a bis-(C₃-C₁₂alkyl) ester of a C₃-C₁₂alkyl-phosphonic acid;
and wherein the optional one, two or more further herbicidal compositions each independently comprise(s) one or more further herbicides.

35. A method as claimed in claim 34, wherein the optional one or more further herbicides, if mixed in the container, are suitable for controlling and/or inhibiting the growth of dicotyledonous and/or broadleaf weeds.

36. A method as claimed in claim 34, wherein the one, two or more further herbicidal compositions, which each independently comprise(s) one or more further herbicides, are mixed in the container and comprise:
(iiia) pyrasulfotole or an agriculturally-acceptable salt thereof; and
(iiib) bromoxynil, or one or more C₄-C₁₂alkanoate esters thereof, or the butyrate ester thereof, or an agriculturally-acceptable base-addition salt thereof.

37. A method as claimed in claim 34, wherein the one, two or more further herbicidal compositions, which each independently comprise(s) one or more further herbicides, are mixed in the container and comprise:
(iiic) MCPA, or a C₁-C₁₂alkyl ester or a 2-(C₁-C₆alkoxy)C₂-C₄alkyl-ester thereof, or an agriculturally-acceptable base-addition salt thereof; and
(iiid) a fourth herbicide which is: florasulam, prosulfuron, triasulfuron, or an agriculturally-acceptable base-addition salt of any of these.

38. A method as claimed in claim 34, wherein the first, liquid, herbicidal composition is in the form of an emulsifiable concentrate.

39. A method as claimed in claim 38, wherein the first, liquid, herbicidal composition is in the form of an emulsifiable concentrate, and contains less than 1% w/w of water by weight of the first, liquid, herbicidal composition.

40. A method as claimed in claim 34, wherein the dicotyledonous and/or broadleaf weeds are weeds from the genus Kochia, Polygonum, Fallopia, Salsola, Descurainia, Helianthus, Lactuca, Solanum, Sinapsis, Amaranthus, Brassica, Chenopodium and/or Fagopyrum.

41. A method as claimed in claim 40, wherein, when the weeds are from the genus Kochia, Polygonum, Fallopia, Salsola, Descurainia, Solanum, Sinapsis, Amaranthus, Brassica, Chenopodium and/or Fagopyrum then they have a height of up to 12 cm, at the time of application of the liquid herbicidal composition; and when the weeds are from the genus Helianthus and/or Lactuca then they have 1-5 leaves, at the time of application of the liquid herbicidal composition.

42. A method as claimed in claim 40, wherein the dicotyledonous and/or broadleaf weeds are weeds from the genus Kochia, Polygonum, Fallopia, Salsola, Descurainia, Helianthus, Lactuca, Sinapsis and/or Amaranthus.

43. A method as claimed in claim 42, wherein the dicotyledonous and/or broadleaf weeds are weeds from the genus Kochia, Salsola, Descurainia, Helianthus, Lactuca and/or Sinapsis.

44. A method as claimed in claim 43, wherein the dicotyledonous and/or broadleaf weeds are weeds from the genus Kochia, Salsola, Descurainia and/or Helianthus.

45. A method as claimed in claim 44, wherein the dicotyledonous and/or broadleaf weeds are weeds from the genus Kochia.

46. A method as claimed in claim 45, wherein the weeds from the genus Kochia have a height of up to 12 cm, at the time of application of the liquid herbicidal composition.

47. A method as claimed in claim 45, wherein the weeds from the genus Kochia are present in a density of from 250 to 700 plants/m², at the time of application of the liquid herbicidal composition.

48. A method as claimed in claim 34, which is also a method for controlling and/or inhibiting the growth of monocotyledonous grassy weeds.

49. A method as claimed in claim 34, wherein:
the first liquid herbicidal composition is in the form of an emulsifiable concentrate;
the first liquid herbicidal composition comprises from 1% to 20% pinoxaden, by weight of the first liquid herbicidal composition;
the first liquid herbicidal composition comprises from 2% to 30% of the ester of fluoroxypyr (measured as the ester), by weight of the first liquid herbicidal composition;
the weight ratio of the pinoxaden to the ester of fluoroxypyr (calculated as the equivalent amount of fluoroxypyr free carboxylic acid, i.e. calculated as the fluoroxypyr “acid equivalent” (AE)) is from 60:70 to 60:250;
the built-in phosphate and/or phosphonate adjuvant comprises tris-(2-ethylhexyl) phosphate, tris-n-octyl phosphate, tris-[2-(n-butoxy)ethyl]phosphate, bis-(2-ethylhexyl) (2-ethylhexyl)phosphonate, bis-(2-ethylhexyl) (n-octyl)phosphonate and/or di-n-butyl (n-butyl)phosphonate; and
the built-in phosphate and/or phosphonate adjuvant is present in from 10% to 60% by weight of the first liquid herbicidal composition.

50. A method as claimed in claim 34, wherein the first liquid herbicidal composition is in the form of an emulsifiable concentrate and comprises, by weight of the first liquid herbicidal composition:
(i) from 1% to 20% pinoxaden;
(ii) from 2% to 30% of the ester of fluoroxypyr (measured as the ester);
(iii) from 10% to 60% of the built-in phosphate and/or phosphonate adjuvant;
(iv) from 1% to 20% of one or more emulsifiers;
(v) from 8% to 40% of an alcohol solvent comprising tetrahydrofurfuryl alcohol, 2-methyl-pentane-2,4-diol, 4-hydroxy-4-methyl-pentane-2-one, benzyl alcohol, 2-ethylhexanol, n-octanol, cyclohexanol, lactic acid methyl ester, lactic acid butyl ester, benzyl lactate, or a mixture of two or more of these alcohols; and
(vi) from 10% to 45% of heavy aromatic hydrocarbon solvent;
and wherein the weight ratio of the pinoxaden to the ester of fluoroxypyr (calculated as the equivalent amount of fluoroxypyr free carboxylic acid, i.e. calculated as the fluoroxypyr “acid equivalent” (AE)) is: from 60:70 to 60:160.

51. A method as claimed in claim 50, wherein:
the alcohol solvent is present in from 15% to 40% by weight of the first liquid herbicidal composition, and the alcohol solvent comprises 96% or more of tetrahydrofurfuryl alcohol by weight of the alcohol solvent; and
the weight ratio of the heavy aromatic hydrocarbon solvent to the alcohol solvent is from 1.5:1 to 0.5:1;
and the alcohol solvent and/or the first liquid herbicidal composition comprises a boron-based stabilizer which comprises:
(a) a metal borohydride in which the metal is an alkali metal or an alkaline earth metal; and/or
(b1) a metal borate in which the metal is an alkali metal or an alkaline earth metal; and/or
(b2) a compound of formula M⁺ B(H)ₙ(OR)ₘ⁻ wherein M is an alkali metal or an alkaline earth metal, n is 0, 1, 2, or 3, m is 1, 2, 3 or 4 and n+m is 4, and wherein each OR group, independently of any other OR group, is C₁-C₈alkoxy, C₃-C₆cycloalkoxy, (tetrahydrofuran-2-yl)methoxy, benzyloxy, or phenoxy;
and wherein the boron-based stabilizer is present in the alcohol solvent in from 0.001% to 0.1% by weight of the alcohol solvent, and/or the boron-based stabilizer is present in the first liquid herbicidal composition in from 0.0002% to 0.02% by weight of the first liquid herbicidal composition.

52. A method as claimed in claim 34, wherein the weight ratio of the pinoxaden to the ester of fluoroxypyr (calculated as the equivalent amount of fluoroxypyr free carboxylic acid, i.e. calculated as the fluoroxypyr “acid equivalent” (AE)) is from 60:70 to 60:160.

53. A method as claimed in claim 34, wherein the built-in phosphate and/or phosphonate adjuvant comprises tris-(2-ethylhexyl) phosphate.

54. A method as claimed in claim 53, wherein the built-in phosphate and/or phosphonate adjuvant is present in from 10% to 60% by weight of the first liquid herbicidal composition.

55. A liquid herbicidal composition, comprising a mixture of:
(i) pinoxaden;
(ii) a C₁-C₁₂alkyl ester or a 2-(C₁-C₆alkoxy)C₂-C₄alkyl-ester of fluoroxypyr;
(iii) pyrasulfotole or an agriculturally-acceptable salt thereof; and
(iv) bromoxynil, or one or more C₄-C₁₂alkanoate esters thereof, or the butyrate ester thereof, or an agriculturally-acceptable base-addition salt thereof.

56. A liquid herbicidal composition as claimed in claim 55, which also comprises a built-in phosphate and/or phosphonate adjuvant; wherein the built-in phosphate and/or phosphonate adjuvant comprises a tris-[C₄-C₁₂alkyl or 2-(C₂-C₆alkoxy)C₂-C₄alkyl-]ester of phosphoric acid and/or a bis-(C₃-C₁₂alkyl) ester of a C₃-C₁₂alkyl-phosphonic acid.

57. A liquid herbicidal composition as claimed in claim 55, wherein the weight ratio of the pinoxaden to the ester of fluoroxypyr (calculated as the equivalent amount of fluoroxypyr free carboxylic acid, i.e. calculated as the fluoroxypyr “acid equivalent” (AE)) is from 60:70 to 60:250.

58. A liquid herbicidal composition as claimed in claim 55, which is an aqueous liquid herbicidal composition suitable for spraying onto a field.

59. A liquid herbicidal composition as claimed in claim 55, wherein:
the weight ratio of the pyrasulfotole or the agriculturally-acceptable salt thereof (measured as the salt-free compound) to the ester of fluoroxypyr (calculated as the equivalent amount of fluoroxypyr free carboxylic acid, i.e. calculated as the fluoroxypyr “acid equivalent” (AE)) is from 50:70 to 20:250; and
the weight ratio of the bromoxynil or the ester or salt thereof (calculated as the bromoxynil “acid equivalent” (AE)) to the ester of fluoroxypyr (calculated as the equivalent amount of fluoroxypyr free carboxylic acid, i.e. calculated as the fluoroxypyr “acid equivalent” (AE)) is from 250:70 to 100:250; and
the weight ratio of the pyrasulfotole or the agriculturally-acceptable salt thereof (measured as the salt-free compound) to the bromoxynil or the ester or salt thereof (calculated as the bromoxynil “acid equivalent” (AE)) is from 50:100 to 20:250.

60. A liquid herbicidal composition, comprising a mixture of:
(i) pinoxaden;
(ii) a C₁-C₁₂alkyl ester or a 2-(C₁-C₆alkoxy)C₂-C₄alkyl-ester of fluoroxypyr;
(iii) MCPA, or a C₁-C₁₂alkyl ester or a 2-(C₁-C₆alkoxy)C₂-C₄alkyl-ester thereof, or an agriculturally-acceptable base-addition salt thereof; and
(iv) a fourth herbicide which is: florasulam, prosulfuron, triasulfuron, or an agriculturally-acceptable base-addition salt of any of these.

61. A liquid herbicidal composition as claimed in claim 60, which also comprises a built-in phosphate and/or phosphonate adjuvant; wherein the built-in phosphate and/or phosphonate adjuvant comprises a tris-[C₄-C₁₂alkyl or 2-(C₂-C₆alkoxy)C₂-C₄alkyl-]ester of phosphoric acid and/or a bis-(C₃-C₁₂alkyl) ester of a C₃-C₁₂alkyl-phosphonic acid.

62. A liquid herbicidal composition as claimed in claim 60, wherein the weight ratio of the pinoxaden to the ester of fluoroxypyr (calculated as the equivalent amount of fluoroxypyr free carboxylic acid, i.e. calculated as the fluoroxypyr “acid equivalent” (AE)) is from 60:70 to 60:250.

63. A liquid herbicidal composition as claimed in claim 60, which is an aqueous liquid herbicidal composition suitable for spraying onto a field.

64. A liquid herbicidal composition as claimed in claim 60,
wherein the weight ratios of the active ingredients are as follows:
the weight ratio of the MCPA or the ester or salt thereof (calculated as the MCPA “acid equivalent” (AE)) to the ester of fluoroxypyr (calculated as the equivalent amount of fluoroxypyr free carboxylic acid, i.e. calculated as the fluoroxypyr “acid equivalent” (AE)) is: from 700:70 to 120:250;
and
the weight ratio of the florasulam or the salt thereof (calculated as the florasulam “acid equivalent” (AE)) to the ester of fluoroxypyr (calculated as the equivalent amount of fluoroxypyr free carboxylic acid, i.e. calculated as the fluoroxypyr “acid equivalent” (AE)) is: from 10:70 to 2:250; and/or
the weight ratio of the prosulfuron or the salt thereof (calculated as the prosulfuron “acid equivalent” (AE)) to the ester of fluoroxypyr (calculated as the equivalent amount of fluoroxypyr free carboxylic acid, i.e. calculated as the fluoroxypyr “acid equivalent” (AE)) is: from 30:70 to 5:250; and/or
the weight ratio of the triasulfuron or the salt thereof (calculated as the triasulfuron “acid equivalent” (AE)) to the ester of fluoroxypyr (calculated as the equivalent amount of fluoroxypyr free carboxylic acid, i.e. calculated as the fluoroxypyr “acid equivalent” (AE)) is: from 20:70 to 5:250.
